(19) United States
(12) Patent Application Publication
(10) Pub. No.: US 2025/0370471 A1
(43) Pub. Date: Dec. 4, 2025

(54) MATERIALS HANDLING FIELD CREATION USING LOCATION DATA

(71) Applicant: Crown Equipment Corporation, New Bremen, OH (US)

(72) Inventors: Benjamin Morelli, Auckland (NZ); Ryan Estep, Auckland (NZ); Dustin Seger, Sharonville, OH (US); Dave Seger, Versailles, OH (US); Mike Corbett, Macedonia, OH (US); Mark Addison, Ludlow Falls, OH (US); Gary Wolters, Coldwater, OH (US); Jamison Frady, Sidney, OH (US); Matt Niekamp, Celina, OH (US)

(73) Assignee: Crown Equipment Corporation, New Bremen, OH (US)

(21) Appl. No.: 19/221,986

(22) Filed: May 29, 2025

Related U.S. Application Data
(60) Provisional application No. 63/654,613, filed on May 31, 2024.

(51) Int. Cl. G05D 1/622; B66F 9/065; G05D 1/222; G05D 1/244; G05D 1/245; G05D 101/00; G05D 105/28; G05D 107/70; G05D 111/10; G05D 111/30; G05D 111/40; G05D 111/50

(52) U.S. Cl. CPC G05D 1/637; B66F 9/065; G05D 1/222; G05D 1/244; G05D 1/245; G05D 2101/22; G05D 2105/28; G05D 2107/70; G05D 2111/17; G05D 2111/30; G05D 2111/40; G05D 2111/52; G05D 2111/54; G05D 2111/58

(57) ABSTRACT

Embodiments provided herein include systems and methods for location-based field shaping. One embodiment of a system includes a materials handling vehicle and a computing device that are configured to receive location data via at least one of the plurality of transceiver anchors, receive sensor data from at least one sensor related to the characteristic of operation of the materials handling vehicle, and determine a first location of the materials handling vehicle in the covered environment. Some embodiments may be configured to determine a vector of movement of the materials handling vehicle, determine a shaped detection field for the materials handling vehicle from the vector of movement, and detect an object that encroaches on the shaped detection field. Some embodiments may be configured to send information to the materials handling vehicle to alter operation of the materials handling vehicle to reduce a likelihood of collision with the object.

### CROSS REFERENCE

This application claims the benefit of U.S. Provisional Application Ser. No. 63/654,613, filed May 31, 2024, which is hereby incorporated by reference in its entirety.

### BACKGROUND

Vehicles that operate in closed environments, such as warehouses are often required to maneuver and traverse tights spaces. Many of the vehicles being used in these types of environments include forklifts, trailers, and/or other components that may reduce the visibility of the user. As these vehicles are often very heavy and difficult to maneuver, it can often be difficult for an operator to identify likely collisions with other vehicles, personnel, racking, and/or other objects in the environment.

Current solutions may utilize vehicle-mounted systems, such as vision-based sensors, to provide advanced object detection and better visibility for a user. While these current solutions have improved object detection, these current solutions lack the ability to detect, alert, and avoid many objects that that the vehicle encounters in the environment, while maintaining operational efficiencies. As such, a need in the industry exists for improved object detection.

### SUMMARY

Systems and methods for field shaping are described. A first aspect includes a system comprising: a materials handling vehicle in an covered environment that includes a first sensor for detecting a direction of motion of the materials handling vehicle, and a second sensor for detecting a steer angle of the materials handling vehicle; a computing device that includes a processor and a memory component, the memory component storing logic that, when executed by the processor, causes the system to perform at least the following: receive data from the materials handling vehicle related to the direction of motion and the steer angle of the materials handling vehicle, as determined via the first sensor and the second sensor; determine, from the data, a vector of movement of the materials handling vehicle; determine, based on the vector of movement of the materials handling vehicle, a shaped detection field, wherein the shaped detection field is configured for monitoring a space along the vector of movement; implement the shaped detection field for the materials handling vehicle; detect an object that encroaches on the shaped detection field; and send information to the materials handling vehicle to alter operation of the materials handling vehicle to move the materials handling vehicle such that the object is out of the shaped detection field.

A second aspect includes the first aspect, wherein the shaped detection field is selected from a plurality of preconfigured shaped detection fields based on at least one of the following: vehicle type, vehicle speed, the steer angle, or location in the covered environment.

A third aspect includes the first aspect and/or the second aspect, wherein the logic further causes the system to perform at least the following: receive new sensor data of the materials handling vehicle in the covered environment; select a predetermined shaped detection field for the materials handling vehicle; and implement the predetermined shaped detection field for the materials handling vehicle.

A fourth aspect includes any of the first aspect through the third aspect, wherein the first sensor includes at least one of the following: a wheel speed sensor, an odometer, an accelerometer, a magnet, or an onboard inertial measurement unit (IMU) to determine whether the materials handling vehicle is moving forward or backward.

A fifth aspect includes any of the first aspect through the fourth aspect, wherein the second sensor includes at least one of the following: a steering wheel sensor or a gyroscope to determine an amount of turn of the materials handling vehicle.

A sixth aspect includes any of the first aspect through the fifth aspect, wherein sending information to the materials handling vehicle to alter operation of the materials handling vehicle to move the materials handling vehicle such that the object is out of the shaped detection field includes at least one of the following: sending an alert to a user of the materials handling vehicle or sending a control signal to the materials handling vehicle.

A seventh aspect includes any of the first aspect through the sixth aspect, wherein determining the shaped detection field includes determining, based on the direction of motion and the steer angle, probabilities for a plurality of spaces that the materials handling vehicle will move and forming the shaped detection field on only a subset of the plurality of spaces with probabilities that meet or exceed a predetermined probability threshold.

An eighth aspect includes any of the first aspect through the seventh aspect, wherein determining the shaped detection field includes determining, based on the direction of motion and the steer angle, a predicted vector of movement of the materials handling vehicle.

A ninth aspect includes a method comprising: receiving, by a computing device, data from a materials handling vehicle in a covered environment, wherein the data includes a direction of motion of the materials handling vehicle and a steer angle of the materials handling vehicle as detected by at least one on-board vehicle sensor; determining, by the computing device, from the data, a vector of movement of the materials handling vehicle; determining, by the computing device, based on the vector of movement of the materials handling vehicle, a shaped detection field, wherein the shaped detection field is configured for monitoring a space that is defined based on a probability of the materials handling vehicle moving into the space; implementing, by the computing device, the shaped detection field for the materials handling vehicle; detecting, by the computing device, an object that encroaches on the shaped detection field; and sending, by the computing device, information to the materials handling vehicle to alter operation of the materials handling vehicle to move the materials handling vehicle such that the object is out of the shaped detection field.

A tenth aspect includes the ninth aspect, wherein the shaped detection field is selected from a plurality of preconfigured shaped detection fields based on at least one of the following: vehicle type, vehicle speed, the steer angle, or location in the covered environment.

An eleventh aspect includes the ninth aspect and/or the tenth aspect, further comprising receiving new sensor data of the materials handling vehicle in the covered environment; selecting a predetermined shaped detection field for the materials handling vehicle; and implementing the predetermined shaped detection field for the materials handling vehicle.

A twelfth aspect may include any of the ninth aspect through the eleventh aspect, wherein the data is received from at least one of the following: a wheel speed sensor, an odometer, an accelerometer, a magnet, an onboard inertial measurement unit (IMU), a steering wheel sensor or a gyroscope to determine an amount of turn of the materials handling vehicle.

A thirteenth aspect may include the any of the ninth aspect through the twelfth aspect, wherein sending information to the materials handling vehicle to alter operation of the materials handling vehicle to move the materials handling vehicle such that the object is out of the shaped detection field includes at least one of the following: sending an alert to a user of the materials handling vehicle or sending a control signal to the materials handling vehicle.

A fourteenth aspect may include any of the ninth aspect through the thirteenth aspect, wherein determining the shaped detection field includes determining, based on the direction of motion and the steer angle, probabilities for a plurality of spaces that the materials handling vehicle will move and forming the shaped detection field on only a subset of the plurality of spaces with probabilities that meet or exceed a predetermined probability threshold.

A fifteenth aspect may include a system comprising a system comprising: a materials handling vehicle for traversing a covered environment; a first sensor coupled to the materials handling vehicle, the first sensor for detecting a direction of motion of the materials handling vehicle, a second sensor coupled to the materials handling vehicle, the second sensor for detecting a steer angle of the materials handling vehicle; and a computing device that includes a processor and a memory component, the memory component storing logic that, when executed by the processor, causes the system to perform the following: receive data from the materials handling vehicle related to the direction of motion and the steer angle of the materials handling vehicle as detected by at least one of the following: the first sensor or the second sensor; determine, from the data, a vector of movement of the materials handling vehicle; determine, based on the vector of movement of the materials handling vehicle, a shaped detection field, wherein the shaped detection field is determined by predicting a path of travel of the materials handling vehicle; implement the shaped detection field for the materials handling vehicle; detect an object that encroaches on the shaped detection field; and send information to the materials handling vehicle to alter operation of the materials handling vehicle to move the materials handling vehicle such that the object is out of the shaped detection field.

A sixteenth aspect may include the fifteenth aspect, wherein the shaped detection field is selected from a plurality of preconfigured shaped detection fields based on at least one of the following: vehicle type, vehicle speed, the steer angle, or location in the covered environment.

A seventeenth aspect may include the sixteenth aspect, wherein the logic further causes the system to perform at least the following: receive new sensor data of the materials handling vehicle in the covered environment; select a different predetermined shaped detection field for the materials handling vehicle; and implement the different predetermined shaped detection field for the materials handling vehicle.

An eighteenth aspect includes the sixteenth aspect and/or the seventeenth aspect, wherein the first sensor includes at least one of the following: a wheel speed sensor, an odometer, an accelerometer, a magnet, or an onboard inertial measurement unit (IMU) to determine whether the materials handling vehicle is moving forward or backward and wherein the second sensor includes at least one of the following: a steering wheel sensor or a gyroscope to determine an amount of turn of the materials handling vehicle.

A nineteenth aspect includes any of the sixteenth aspect through the eighteenth aspect, wherein sending information to the materials handling vehicle to alter operation of the materials handling vehicle to move the materials handling vehicle such that the object is out of the shaped detection field includes at least one of the following: sending an alert to a user of the materials handling vehicle or sending a control signal to the materials handling vehicle.

A twentieth aspect includes any of the sixteenth aspect through the nineteenth aspect, wherein determining the shaped detection field includes determining, based on the direction of motion and the steer angle, probabilities for a plurality of spaces that the materials handling vehicle will move and forming the shaped detection field on only a subset of the plurality of spaces with probabilities that meet or exceed a predetermined probability threshold.

A twenty-first aspect includes a system comprising a system for location-based field shaping comprising: a materials handling vehicle in a covered environment that includes a vehicle transceiver for receiving a communication from a plurality of transceiver anchors that are affixed to stationary objects within the covered environment, wherein the materials handling vehicle further includes at least one sensor for detecting a characteristic of operation of the materials handling vehicle; and a computing device that includes a processor and a memory component, the memory component storing logic that, when executed by the processor, causes the system to perform the following: receive location data via at least one of the plurality of transceiver anchors, the data related to a location of the materials handling vehicle in the covered environment; receive sensor data from the at least one sensor related to the characteristic of operation of the materials handling vehicle; determine, from the location data, a first location of the materials handling vehicle in the covered environment; determine, from the sensor data, a vector of movement of the materials handling vehicle, wherein the vector of movement includes an orientation of the materials handling vehicle; determine a shaped detection field for the materials handling vehicle from the vector of movement of the materials handling vehicle and the first location of the materials handling vehicle, wherein the shaped detection field is configured for monitoring an area that is defined based on a probability of the materials handling vehicle moving into the area; detect an object that encroaches on the shaped detection field; and send information to the materials handling vehicle to alter operation of the materials handling vehicle to reduce a likelihood of collision with the object.

A twenty-second aspect includes the twenty-first aspect, wherein the logic is further configured to perform at least the following: determine a second location of the materials handling vehicle in the covered environment; determine that the second location is in a different location of the covered environment than the first location; and adjust the shaped detection field based on the different sector of the covered environment.

A twenty-third aspect includes the twenty-first aspect and/or the twenty-first aspect, wherein the logic further causes the system to perform at least the following: determine that the location is identified as providing a zone that provides zone-based shaped detection field; and implement the zone-based shaped detection field while the materials handling vehicle is located in the zone.

A twenty-fourth aspect includes any of the twenty-first aspect through the twenty-third aspect, wherein the shaped detection field is selected from a plurality of preconfigured shaped detection fields based on at least one of the following: space, traffic, vehicle type, or operator.

A twenty-fifth aspect includes any of the twentieth aspect through the twenty-fourth aspect, wherein the logic further causes the system to provide a live map to an administrator, wherein the live map provides a representation of at least one of the following: the materials handling vehicle, the orientation, or the shaped detection field.

A twenty-sixth aspect includes any of the twenty-first aspect through the twenty-fifth aspect, wherein the plurality of transceiver anchors are ultra-wide band (UWB) antennas.

A twenty-seventh aspect includes any of the twentieth aspect through the twenty-sixth aspect, wherein the object includes at least one of the following: a second vehicle, a pedestrian, or a zone.

A twenty-eighth aspect includes any of the twenty-first aspect through the twenty-seventh aspect, wherein the at least one sensor includes at least one of the following: a light radar (LiDAR), a steering wheel sensor, an odometer, a wireline sensor, a gyroscope, an accelerometer, a magnet, a single UWB transceiver, or an onboard inertial measurement unit (IMU).

A twenty-ninth aspect includes a method for location-based field shaping comprising: receiving, by a computing device, location data related to a location of the materials handling vehicle in a covered environment; receiving, by the computing device, sensor data from a sensor on the materials handling vehicle related to a characteristic of operation of the materials handling vehicle; determining, by the computing device, from the location data, a first location of the materials handling vehicle in the covered environment; determining, by the computing device, from the sensor data, a vector of movement, wherein the vector of movement includes an orientation of the materials handling vehicle; creating, by the computing device, a shaped detection field for the materials handling vehicle from the vector of movement of the materials handling vehicle and the first location of the materials handling vehicle, wherein the shaped detection field is configured for monitoring an area that is defined based on a probability of the materials handling vehicle moving into the area; detecting, by the computing device, an object that encroaches on the shaped detection field; and sending, by the computing device, information to the materials handling vehicle to alter operation of the materials handling vehicle to reduce a likelihood of collision with the object.

A thirtieth aspect includes the twenty-ninth aspect, further comprising: determining a second location of the materials handling vehicle in the covered environment; determining that the second location is in a different location of the covered environment than the first location; and adjusting the shaped detection field based on the different location of the covered environment.

A thirty-first aspect includes the twenty-ninth aspect and/or the thirtieth aspect, further comprising: determine that the location is identified as a zone that provides a zone-based shaped detection field; and implement the zone-based shaped detection field while the materials handling vehicle is located in the location.

A thirty-second aspect includes any of the twenty-ninth aspect through the thirty-first aspect, wherein the shaped detection field is selected from a plurality of preconfigured shaped detection fields based on at least one of the following: space, traffic, vehicle type, or operator.

A thirty-third aspect includes any of the twenty-ninth aspect through the thirty-second aspect, further comprising providing a live map to an administrator, wherein the live map provides a representation of at least one of the following: the materials handling vehicle, the orientation, or the shaped detection field.

A thirty-fourth aspect includes any of the twenty-ninth aspect through the thirty-third aspect, wherein the object includes at least one of the following: a second vehicle, a pedestrian, or a zone.

A thirty-fifth aspect includes any of the twenty-ninth aspect through the thirty-fourth aspect, wherein the sensor includes at least one of the following: a light radar (LiDAR), a steering wheel sensor, an odometer, a wireline sensor, a gyroscope, an accelerometer, a magnet, a single UWB transceiver, or an onboard inertial measurement unit (IMU).

A thirty-sixth aspect includes a system for location-based field shaping comprising: a materials handling vehicle for traversing a covered environment; at least one vehicle sensor on the materials handling vehicle for detecting a characteristic of operation of the materials handling vehicle; a vehicle transceiver on the materials handling vehicle for communicating with a plurality of transceiver anchors that are placed on respective stationary objects within the covered environment for detecting a location of the materials handling vehicle in the covered environment; and a computing device that includes a processor and a memory component, the memory component storing logic that, when executed by the processor, causes the system to perform the following: receive location data from the materials handling vehicle via the vehicle transceiver, the location data related to a location of the materials handling vehicle in the covered environment; receive sensor data from the at least one vehicle sensor related to the characteristic of operation of the materials handling vehicle; determine, from the location data, a first location of the materials handling vehicle in the covered environment; determine, from the sensor data, a vector of movement of the materials handling vehicle, wherein the vector of movement includes an orientation of the materials handling vehicle; determine a shaped detection field for the materials handling vehicle from the vector of movement of the materials handling vehicle and the first location of the materials handling vehicle, wherein the shaped detection field is configured for monitoring an area that is defined based on a probability of the materials handling vehicle moving into the area; detect an object that encroaches on the shaped detection field; and send information to the materials handling vehicle to alter operation of the materials handling vehicle to reduce a likelihood of collision with the object.

A thirty-seventh aspect includes the thirty-sixth aspect, wherein the logic is further configured to perform at least the following: determine a second location of the materials handling vehicle in the covered environment; determine that the second location is in a different location of the covered environment than the first location; and adjust the shaped detection field based on the different location of the covered environment.

A thirty-eighth aspect includes the thirty-sixth aspect and/or the thirty-seventh aspect, wherein the shaped detection field is selected from a plurality of preconfigured shaped detection fields based on at least one of the following: space, traffic, vehicle type, or operator.

A thirty-ninth aspect includes any of the thirty-sixth aspect through the thirty-eighth aspect, wherein the plurality of transceiver anchors are ultra-wide band (UWB) transceivers.

A fortieth aspect includes any of the thirty-sixth aspect through the thirty-ninth aspect, wherein the at least one vehicle sensor includes at least one of the following: a light radar (LiDAR), a steering wheel sensor, an odometer, a wireline sensor, a gyroscope, an accelerometer, a magnet, a single UWB transceiver, or an onboard inertial measurement unit (IMU).

A forty-first aspect includes a system for determining orientation of a materials handling vehicle comprising: a materials handling vehicle that includes a single ultra wide band (UWB) antenna and at least one vehicle sensor; and a computing device that includes a processor and a memory component, the memory component storing logic that, when executed by the processor, causes the system to perform at least the following: receive data related to a first plurality of locations of the materials handling vehicle, determined via the UWB antenna; determine, from the data, a first initial orientation of the materials handling vehicle; receive vehicle sensor data from the at least one vehicle sensor on the materials handling vehicle; determine an updated vehicle orientation and an updated vehicle location, based on the data and the vehicle sensor data; and provide a user interface that includes a depiction of the materials handling vehicle in the updated vehicle orientation and the updated vehicle location.

A forty-second aspect includes the forty-first aspect, wherein the logic further causes the system to perform at least the following: determine that at least one of the following is against a predetermined policy: the updated vehicle orientation or the updated vehicle location; and provide an alert to a user of the materials handling vehicle to correct at least one of the following: the updated vehicle orientation or the updated vehicle location.

A forty-third aspect includes the forty-first aspect and/or the forty-second aspect, wherein the logic further causes the system to remotely adjust at least one of the following: the updated vehicle orientation or the updated vehicle location.

A forty-fourth aspect includes any of the forty-first aspect through the forty-third aspect, wherein the logic further causes the system to perform at least the following: receive data related to a second plurality of locations of the materials handling vehicle, determined via the UWB antenna; determine a second initial orientation of the materials handling vehicle; compare the second initial orientation of the materials handling vehicle with the updated vehicle orientation; and in response to determining that the second initial orientation of the materials handling vehicle varies from the updated vehicle orientation by a predetermined threshold, replace the updated vehicle orientation with the second initial orientation.

A forty-fifth aspect includes any of the forty-first aspect through the forty-fourth aspect, wherein the at least one vehicle sensor includes at least one of the following: a wheel speed sensor, an odometer, a steering wheel sensor, a wireline sensor, a gyroscope, and accelerometer, a magnet, or a light detection and ranging (LiDAR) sensor.

A forty-sixty aspect includes any of the forty-first aspect through the forty-fifth aspect, wherein the user interface provides at least near real-time depiction of location and orientation of the materials handling vehicle.

A forty-seventh aspect includes any of the forty-first aspect through the forty-sixth aspect, wherein the materials handling vehicle includes a user option to recalibrate the updated vehicle orientation.

A forty-eighth aspect includes a method for determining orientation of a materials handling vehicle comprising: receiving by the computing device, data related to a first plurality of locations of the materials handling vehicle, determined via a UWB antenna on the materials handling vehicle, wherein the materials handling vehicle only includes one UWB antenna; determining, by the computing device from the data, a first initial orientation of the materials handling vehicle; receiving, by the computing device, vehicle sensor data from a sensor on the materials handling vehicle; determining, by the computing device, an updated vehicle orientation and an updated vehicle location, based on the data and the vehicle sensor data; and providing, by the computing device, a user interface that includes a depiction of the materials handling vehicle in the updated vehicle orientation and the updated vehicle location.

A forty-ninth aspect includes the forty-eighth aspect, further comprising: determining that at least one of the following is against a predetermined policy: the updated vehicle orientation or the updated vehicle location; and providing an alert to a user of the materials handling vehicle to correct at least one of the following: the updated vehicle orientation or the updated vehicle location.

A fiftieth aspect includes the forty-eighth aspect and/or the forty-ninth aspect, further comprising remotely adjusting at least one of the following: the updated vehicle orientation or the updated vehicle location.

A fifty-first aspect includes any of the forty-eighth aspect through the fiftieth aspect, further comprising: receiving data related to a second plurality of locations of the materials handling vehicle, determined via the UWB antenna; determining a second initial orientation of the materials handling vehicle; comparing the second initial orientation of the materials handling vehicle with the updated vehicle orientation; and in response to determining that the second initial orientation of the materials handling vehicle varies from the updated vehicle orientation by a predetermined threshold, replacing the updated vehicle orientation with the second initial orientation.

A fifty-second aspect includes any of the forty-eighth aspect through the fifty-first aspect, wherein the sensor includes at least one of the following: a wheel speed sensor, an odometer, a steering wheel sensor, a wireline sensor, a gyroscope, and accelerometer, a magnet, or a light detection and ranging (LiDAR) sensor.

A fifty-third aspect includes any of the forty-eighth aspect through the fifty-second aspect, wherein the user interface provides at least near real-time depiction of location and orientation of the materials handling vehicle.

A fifty-fourth aspect includes any of the forty-eighth aspect through the fifty-third aspect, wherein the materials handling vehicle includes a user option to recalibrate the updated vehicle orientation.

A fifty-fifth aspect includes a computing device comprising: a processor; and a memory component that stores logic that, when executed by the processor, causes the computing device to perform at least the following: receive data related to a first plurality of locations of the materials handling vehicle, determined via a single UWB antenna on the materials handling vehicle; determine, from the data, a first initial orientation of the materials handling vehicle; receive vehicle sensor data from at least one vehicle sensor on the materials handling vehicle; determine an updated vehicle orientation and an updated vehicle location, based on the data and the vehicle sensor data; and provide a user interface that includes a depiction of the materials handling vehicle in the updated vehicle orientation and the updated vehicle location.

A fifty-sixth aspect includes the fifty-fifth aspect, wherein the logic further causes the computing device to perform at least the following: determine that at least one of the following is against a predetermined policy: the updated vehicle orientation or the updated vehicle location; and provide an alert to a user of the materials handling vehicle to correct at least one of the following: the updated vehicle orientation or the updated vehicle location.

A fifty-seventh aspect includes the fifty-fifth aspect and/or the fifty sixth aspect, wherein the logic further causes the computing device to remotely adjust at least one of the following: the updated vehicle orientation or the updated vehicle location.

A fifty-eighth aspect includes any of the fifty-fifth aspect through the fifty-seventh aspect, wherein the logic further causes the computing device to perform at least the following: receive data related to a second plurality of locations of the materials handling vehicle, determined via the UWB antenna; determine a second initial orientation of the materials handling vehicle; compare the second initial orientation of the materials handling vehicle with the updated vehicle orientation; and in response to determining that the second initial orientation of the materials handling vehicle varies from the updated vehicle orientation by a predetermined threshold, replace the updated vehicle orientation with the second initial orientation.

A fifty-ninth aspect includes any of the fifty-fifth aspect through the fifty-eighth aspect, wherein the at least one vehicle sensor includes at least one of the following: a wheel speed sensor, an odometer, a steering wheel sensor, a wireline sensor, a gyroscope, and accelerometer, a magnet, or a light detection and ranging (LiDAR) sensor.

A sixtieth aspect includes any of the fifty-fifth aspect through the fifty-ninth aspect, wherein the user interface provides at least near real-time depiction of location and orientation of the materials handling vehicle.

Another aspect includes any of the previous aspects, further comprising creating a table that provides a plurality of predetermined shaped detection fields.

Another aspect includes any of the previous aspects, wherein the shaped detection field is determined based on the vehicle meeting a predetermined desired vehicle condition before an end of the shaped detection field.

Another aspect includes any of the previous aspects, wherein the vehicle includes at least one of the following: a steering wheel sensor for detecting a steer angle and an amount of turn, a wheel speed sensor for determining a speed of the vehicle and a direction of motion, an odometer, an onboard accelerometer, a magnet, a gyroscope, a 2-dimensional LiDAR system, a 3-dimensional LiDAR system, a RADAR system, a SONAR system, or a camera system.

Another aspect includes any of the previous aspects, wherein the table includes a plurality of entries associated with vehicle operation and, in response to determining that the vehicle is operating between a plurality of table entries, each with a different shaped detection field, a larger shaped detection field of the table entries is selected.

Another aspect includes any of the previous aspects, wherein the vehicle location logic is located in at least one of the following: the covered environment or a computing device remote from the covered environment.

Another aspect includes any of the previous aspects, wherein the logic includes remote computing logic that is configured as warehouse management software application with RTLS features for users to monitor, manage, and maintain the system, allow for administrators to monitor, configure, update, and maintain the RTLS system.

Another aspect includes any of the previous aspects, wherein the remote computing logic includes at least one of the following: an RTLS live map configured as a graphical facility map showing icons for real time locations of active wireless devices on the network, a reporting module for providing API access to a user to generate its own reports and provide data as part of reports covering traffic and congestion, impacts and near-misses, and route playback, an enhancements module for providing options for users to enhance, define, and manage alerts, notifications, equipment, zones and user data associated with telematics services provided for the vehicle, and a commissioning tools module for setting up and managing the virtual representation of the facility and zones where the system should exercise control and awareness.

Another aspect includes any of the previous aspects, wherein the logic includes at least one of the following: vehicle location logic, which includes a system services module, a geolocation engine, or a policy enforcement module.

Another aspect includes any of the previous aspects, wherein the system services module is configured to monitor operation and health, setup, operate, and/or maintain the RTLS component, wherein the geolocation engine is configured for monitoring the location of the vehicles, and wherein the policy enforcement module is configured to arbitrate and apply policies to vehicles, store field shaping tables, and apply field shaping to the vehicles.

Another aspect includes any of the previous aspects, further comprising performing at least one of the following when the vehicle encounters a zone: altering the shaped detection field stop using the shaped detection field, or utilize a predetermined shaped detection zone for the zone.

Another aspect includes any of the previous aspects, wherein the shaped detection field is determined based on vehicle location being in an area where the vehicle is to turn around.

Another aspect includes any of the previous aspects, further comprising providing a user interface for a user to determine a shaped detection field.

Another aspect includes any of the previous aspects, wherein when the vehicle enters an area of the covered environment corresponding to a payload, a predetermined field may be determined for the vehicle that reflects the likely directions that the vehicle will take to perform a desired task on the payload.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1A depicts an environment-based computing environment for field shaping, according to embodiments provided herein;

FIG. 1B depicts a cloud-based computing environment for field shaping, according to embodiments provided herein;

FIG. 1C depicts a table for selecting a shaped field, according to embodiments provided herein;

FIG. 2 depicts computing infrastructure associated with the remote computing logic and the vehicle location logic from FIGS. 1A and 1B, according to embodiments provided herein;

FIG. 3 depicts a vehicle traversing a route in a covered environment, according to embodiments provided herein;

FIG. 4 depicts a user interface for detecting a location and/or orientation of a vehicle in the covered environment, according to embodiments provided herein;

FIG. 5A depicts a plurality of vehicles with 360 degree fields traversing an environment, according to embodiments provided herein;

FIG. 5B depicts a plurality of vehicles with shaped detection fields traversing an environment, according to embodiments provided herein;

FIG. 5C depicts a shaped detection field that may be created and/or selected for a vehicle, based on a determination that the vector of movement includes a turn and/or travel through a restriction zone, according to embodiments provided herein.

FIG. 5D depicts a shaped detection field that may be created and/or selected for a vehicle, based on vehicle location being in an area where the vehicle is to turn around, according to embodiments provided herein;

FIG. 6 depicts a flowchart for determining a vehicle orientation, according to embodiments provided herein;

FIG. 7 depicts a flowchart for calibrating a vehicle, according to embodiments provided herein;

FIG. 8 depicts a flowchart for field shaping, according to embodiments provided herein;

FIG. 9 depicts another flowchart for field shaping, according to embodiments provided herein; and

FIG. 10 depicts the remote computing device of FIGS. 1A, 1B, according to embodiments provided herein.

### DETAILED DESCRIPTION

Embodiments disclosed herein include systems and methods for field shaping. Some embodiments utilize an ultra-wide band (UWB) location technology with a single transceiver on a vehicle that may be utilized for locating the vehicle in a covered environment. A single vehicle-mounted UWB transceiver communicates to an array of facility mounted UWB transceiver anchors with static, known locations that can then locate the vehicle(s) using time of flight trilateration which determines the position of the vehicle based on its distance to each of the plurality of transceiver anchors placed on respective stationary objects with whom the vehicle is actively communicating. UWB anchors may be communicatively coupled to a remote computing device and/or local computing device to perform this function. UWB tags may be placed on mobile objects, such as pedestrians, pallets, etc. may not be communicatively coupled to a remote computing device and/or local computing device.

Embodiments may also include one or more vehicle sensors (such as a first sensor and/or a second sensor) for determining a direction of motion, meaning whether the vehicle is traveling forward or backward and/or for determining a steer angle of a steering wheel of the vehicle and/or of the vehicle itself. This sensor data may be utilized to calculate an orientation of the vehicle and/or a vector of movement of the vehicle. The vehicle sensors may include a light detection and ranging (LiDAR) sensor, a wheel speed sensor, a steering wheel sensor, an odometer, a wireline sensor, a gyroscope, an accelerometer, a magnet, an onboard inertial measurement unit (IMU), and/or other vehicle sensor. These embodiments may be configured to join sensor data together via sensor fusion to enable vector tracking of the vehicle. Vector tracking enabled by sensor fusion can then be applied to create a shaped detection field that will have less impact to warehouse productivity.

Specifically, some embodiments may utilize UWB data to determine a location of the vehicle in the covered environment over a predetermined timeframe. Additionally, sensor data, such as data related to a turn radius, a vehicle speed, a vehicle direction, etc. may also be collected. This data may be fused tougher such as by weighting each stream of sensor data, based on predetermined criteria (such as position in the covered environment, divergence of a stream of data from a past reading, variance of a stream of data from the other streams of data, etc.). As an example, if UWB data, gyroscope data, and odometry steer angle data are collected, a determination may be made regarding whether the vehicle is located in an aisle or in a free range area. If in an aisle, the UWB data may be assigned a weighting of 10% (due to low reliability of UWB data in this area), the gyroscope data 45% and the odometry steer angle data 45%. Thus, a determination of vehicle position and orientation may be determined; weightings determined; new sensor data received; weights applied; and the vehicle position and orientation adjusted based on the weight adjusted sensor data. This new position and orientation may then be utilized to determine a field shape.

Embodiments may be configured to pre-define shaped detection fields, and store the shaped detection fields in a lookup table with pre-defined data ranges for vehicle speed, steer angle, and/or other data. A shaped detection field may be selected by monitoring the vehicle speed, steer angle, location, etc. Once the shaped detection field is selected from the lookup table, the vehicle sensors may search for objects using that overlap/intersect with the shaped detection field. An alert and/or an instruction to reduce vehicle speed may be provided to assist the operator to avoid a collision. Any detected object outside the shaped detection field may be ignored.

Specifically, some embodiments may utilize onboard (e.g., CAN network) vehicle speed and steer angle data to select between predefined LiDAR fields. These embodiments may utilize a physics model of the vehicle with speed and steer angle inputs to determine a current vector of movement and/or predict a future vector of movement of the vehicle and select or create a shaped detection field that most closely matches that path. In the end, this means that fields curve where the operator is turning and get longer when the vehicle is traveling faster, shorter when the vehicle is traveling slower. Predicting a future vector of movement may include determining a probability that the vehicle will move in a direction and, if that probability meets a predetermined threshold, the predicted vector of movement may be determined and a shaped field may be determined from the predicted vector of movement.

Some embodiments may perform field shaping utilizing vehicle speed and steer angle, as acquired via LiDAR, a steering wheel sensor, a wheel speed sensor, an odometer, a gyroscope, and/or other vehicle sensor data. In some of these embodiments a sensor may be utilized to provide an approximate 180 degree possible field of view in the vector of movement. These embodiments may determine probabilities for a plurality of spaces that the vehicle will move and the shaped detection field may be created from a subset of the plurality of spaces with probabilities that meet or exceed a predetermined probability threshold.

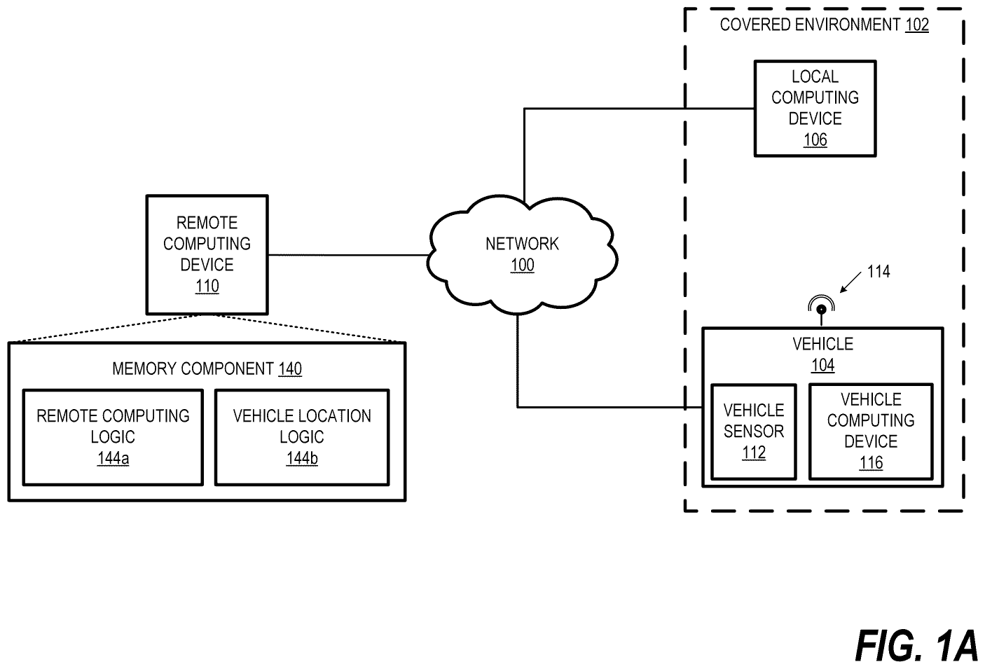

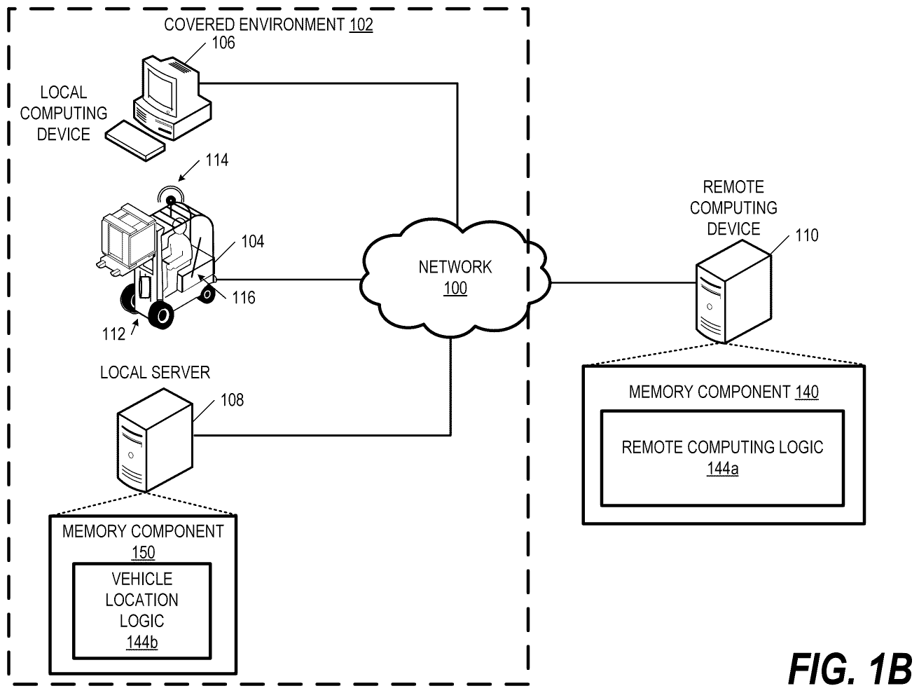

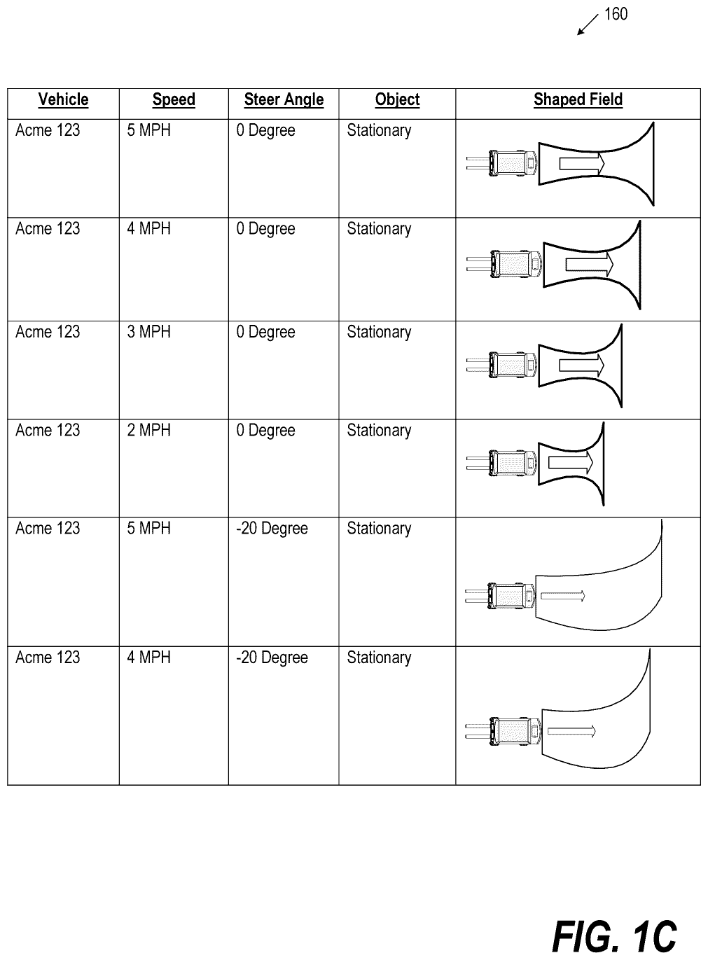

Referring now to the drawings, FIG. 1A depicts an environment-based computing environment for field shaping, according to embodiments provided herein. As illustrated, the computing environment may include a network 100 coupled to components in a covered environment 102, such as a vehicle 104 a local client device 106, and a local server 106b. Also coupled to the network 100 is a remote computing device 110.

The vehicle 104 may be configured as a materials handling vehicle or other vehicle that is configured to traverse a covered environment 102 that includes objects, as described herein. In the context of the present disclosure, it is noted that a “materials handling vehicle” comprises a vehicle primarily designed for towing or lifting and moving a payload such as, for example, a warehouse tugger, a forklift vehicle, a reach vehicle, a turret vehicle, a walkie stacker vehicle, a tow tractor, a pallet vehicle, a high/low, a stacker-vehicle, trailer loader, a sideloader, a fork hoist, or the like.

The covered environment 102 may encompass any indoor or outdoor industrial facility in which vehicles 104 transport goods including, but not limited to, indoor or outdoor industrial facilities that are intended primarily for the storage of goods, such as those where multi-level racks are arranged in aisles, and manufacturing facilities where goods are transported about the facility by vehicles 104 for use in one or more manufacturing processes, as will be shown and described in more detail herein.

The vehicle 104 may include at least one vehicle sensor 112, which may include a steering wheel sensor for detecting a steer angle, a wheel speed sensor for determining a speed of the vehicle 104 and/or for determining a direction of motion, such as whether the vehicle is moving forward or backward, an odometer, an onboard inertial measurement unit (IMU), such as with an accelerometer and/or a gyroscope, (or more than one) for detecting rotational movement of the vehicle 104 and/or objects in the proximity of the vehicle 104. Depending on the particular embodiment, the vehicle sensor 112 may be configured as a 2-dimensional LiDAR system, a 3-dimensional LiDAR system, a RADAR system, a SONAR system, a camera system, and/or other device or system that can detect the presence of objects in the proximity of the vehicle 104. In some embodiments, the vehicle 104 includes only one vehicle sensor 112, while some embodiments are configured such that a plurality of vehicle sensors 112 are coupled to the vehicle 104 and provide a wide angle (e.g. 180 degree, 270 degree, 360 degree) view of objects around the vehicle 104.

It should be understood that each of the LiDAR devices may be a LiDAR scanner capable of detecting objects in a field of view of the LiDAR scanner, such as, for example, the SICK TiM781, the SICK microScan3, or the IDEC SE2L. The remote computing device 110 may receive signals from the LiDAR device indicative of the detected object. The LiDAR devices may be mounted in various locations on the vehicle 104 to detect objects around the vehicle 104, such as, for example, a front, a rear, a top, a side, or the like.

In some embodiments, the vehicle 104 may include a first LiDAR device mounted on a front of the vehicle 104 and a second LiDAR device mounted on a rear of the vehicle 104. The first LiDAR device may detect objects in front of the vehicle 104 when the vehicle 104 is moving in a forward direction. The second LiDAR device may detect objects in rear of the vehicle 104 when the vehicle 104 is moving in a backwards direction. The vehicle 104 may include an operator compartment and a pair of forks for picking cargo within the manufacturing environment where the operator compartment and forks may be raised and lowered to pick cargo from shelves that are above the vehicle 104. The second LiDAR device may be mounted on a portion of the vehicle 104 separate from the operator compartment and forks that is not raised and lowered such that the second LiDAR device is disposed at a static distance away from the ground. When the operator compartment is lowered, the operator compartment may obstruct the view of the second LiDAR device. The vehicle 104 may be configured to raise the operator compartment to a predetermined height above the second LiDAR device when the vehicle 104 is moving in the backwards direction so that the operator compartment does not obstruct the view of the second LiDAR device.

Similarly, while some embodiments are configured to detect objects in proximity of the vehicle 104 via the vehicle sensor 112, some embodiments may be configured to acquire the environment data and construct a virtual representation of an area of the environment around the vehicle 104 from which the object is detected. As discussed in more detail below, these embodiments may utilize the vehicle sensor 112 and/or a vehicle transceiver 114.

As such, embodiments may be configured to receive sensor data related to a direction of motion of the vehicle 104 (e.g., whether the vehicle is moving forward or backward, whether the lift is moving upward or downward, etc.), a steer angle of the vehicle 104, and/or other sensor data to determine an orientation of the vehicle 104. The orientation data may then be utilized to determine a vector of motion, which is used to create a shaped detection field that is tailored to the current operation of the vehicle 104. More specifically, if the covered environment 102 utilizes a UWB system, these embodiments may be configured to determine a location of the vehicle 104. This location data as determined by the UWB system may be configured as a point location, without any indication of vector of movement, orientation, vector of movement, etc. Additionally, this UWB location data may be delayed from real-time and thus may not represent the most current location of the vehicle 104. In these embodiments, vehicle sensors indicate that the vehicle 104 is driving forward and the steering wheel is turned right 20 degrees (e.g., the steer angle). Utilizing the location data with the direction of motion data and the steer angle data, embodiments of the remote computing device 110 and/or local server 106b may be configured to predict a vector of movement of the vehicle 104. The vector of movement may include the orientation data (e.g., which direction is the vehicle 104 pointed). Once the vector of movement is determined, a shaped detection field may be created.

Specifically, some embodiments may be configured to determine vehicle capabilities for one or more vehicles 104 that may be located in the covered environment 102. One or more shaped detection fields may be assigned to the vehicle type, based on a plurality of criteria, such as speed, direction, steering wheel angle, location in the covered environment, zones, other vehicles in the vicinity, etc. Additionally, the shaped fields may be determined based on a predetermined desired vehicle condition. As an example, if the predetermined desired vehicle condition is 1 mile per hour (MPH), the shaped field will be sized and shaped such that if an object enters the field, the vehicle 104 will be able to reach the predetermined desired vehicle condition before reaching the object. As such, shaped fields may also be based on whether objects in the proximity of the vehicle 104 are stationary or moving.

As an example, embodiments may be configured to construct a table, such as depicted in FIG. IC. As will be understood, the actual table may provide shaped fields for each combination of factors, such as, different vehicles, from lowest speed to highest speed for the vehicle, positive speed to negative speed (backward operation), maximum steer angle left to maximum steer angle right, stationary objects, mobile objects, etc. Additionally, table entries may include additional fields, such as zones, vehicle location, etc. Additionally, embodiments may be configured such that the table is created to default to the largest shaped field when the vehicle 104 is operating between table entries. As an example, if the vehicle has 0 steer angle and 4.5 MPH, the table entry will select the shaped field for the 5 MPH operation. Additionally, if the vehicle 104 detects a mobile object in the vicinity, the shaped detection field may increase in size, due to the relatively unpredictable behavior relative to a stationary object. Different types of mobile objects may have different shaped fields (e.g., different types of vehicles) due to the different speeds, turn radiuses, etc.

It should be understood that while some embodiments may be configured to create the one or more tables prior to utilization, some embodiments may be configured such that the local server 106b creates the shaped fields in real time, based on a calculation of getting the vehicle 104 to the predetermined desired vehicle condition.

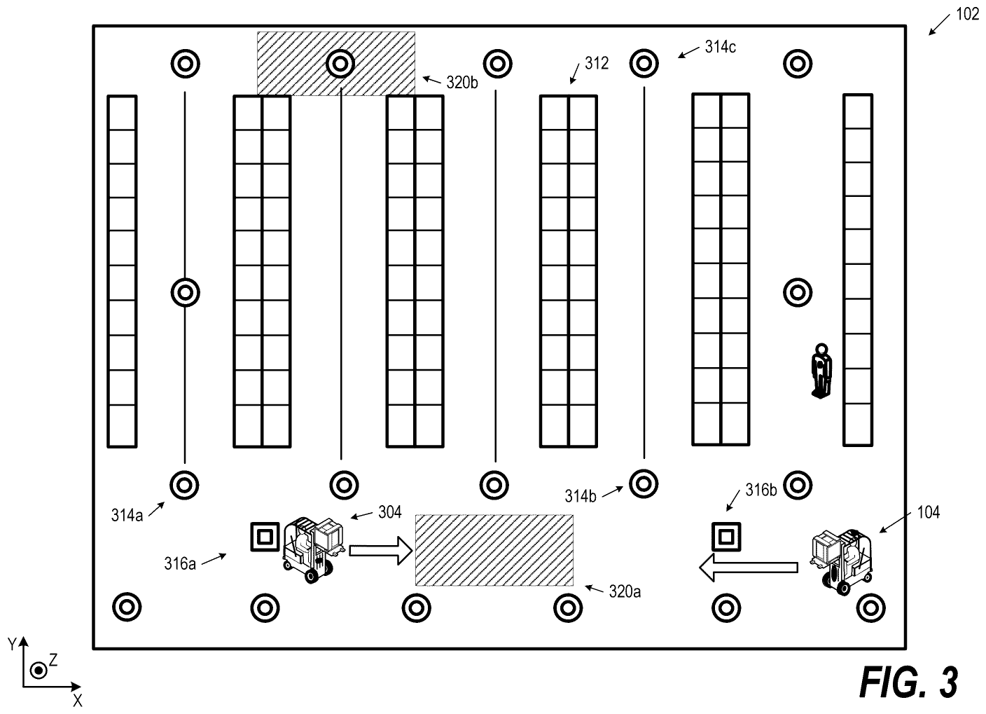

The vehicle 104 may also include the vehicle transceiver 114 for communicating with a transceiver anchor 314, transceiver anchor 316 (FIG. 3), and/or with the remote computing device 110. As described in more detail below, some embodiments may be configured such that the covered environment 102 has a plurality of transceiver anchors 314, 316 positioned at known fixed locations and broadcast a signal that includes an identifier of that wireless transceiver. A vehicle computing device 116 on the vehicle 104 and/or the remote computing device 110 may then determine a current location of the vehicle 104 from the received wireless communication.

The vehicle 104 may include a display (not explicitly shown) to provide one or more user interfaces. The vehicle 104 may include a proximity control module (PCM) as part of the vehicle computing device 116 that communicates with vehicle sensors to arbitrate received data and provide command alerts and slowdowns to the vehicle 104 and equipped system components. The vehicle transceiver 114 may be configured as a UWB transceiver module that receives UWB network data and transmits vehicle data. The vehicle 104 may include a user option to calibrate and/or recalibrate a vehicle orientation.

Also included in FIG. 1A is the remote computing device 110. The remote computing device 110 may be configured as a personal computer, laptop, server, tablet, mobile device, vehicle computing device 116, and/or other computing device that includes the hardware and provides the functionality described herein. It should also be noted that some embodiments may be configured such that at least a portion of the computing described with reference to the remote computing device 110 is embodied in the vehicle computing device 116 that is integrated onto the vehicle 104 and/or otherwise provided locally from the covered environment 102.

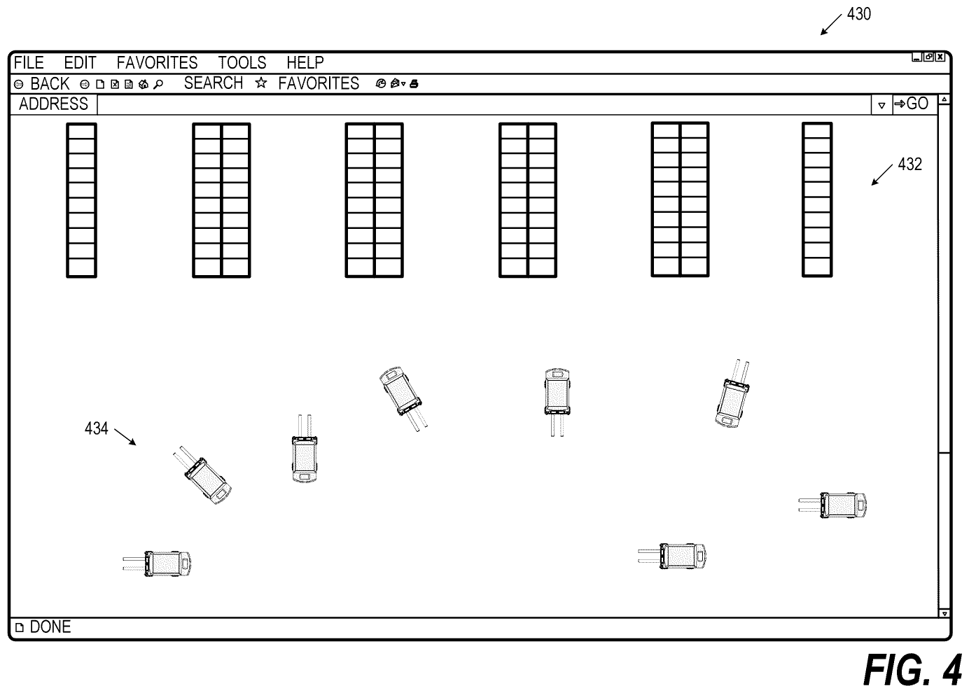

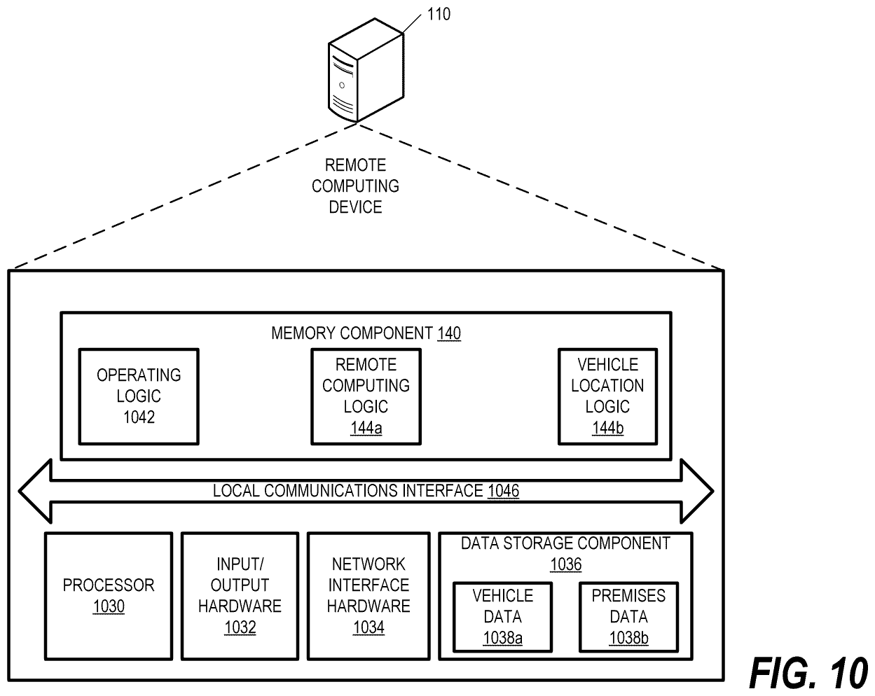

Regardless, the remote computing device 110 may include a plurality of components (described in more detail with reference to FIG. 10), such as a memory component 140. The memory component 140 may be configured as read access memory (RAM), read-only memory (ROM), registers, etc. The memory component 140 may be configured to store logic or other computer-readable instructions, such as remote computing logic 144a. The remote computing logic 144a may include instructions for providing user interfaces to allow a user to define zones, as well as illustrate the covered environment 102. As an example, the remote computing logic 144a may provide the user interface from FIG. 4, discussed in more detail below.

The local client device 106a may be configured as a desktop computer, laptop, tablet, mobile device, server, etc. In some embodiments, the local client device 106a may be configured to provide administrative viewing and controls of the vehicle 104 and/or remote computing device 110. Other administrative controls may also be provided. Additionally, the local server 106b may be configured as a desktop computer, laptop, tablet, mobile device, server, bridge, and/or other computing device that includes memory component 150. The memory component 150 may sore vehicle location logic 144b. The vehicle location logic 144b may be part of a real time location tracking system (RTLS) that be configured to communicate with one or more transceiver anchors, wire guide systems, odometry systems, and/or other extra-vehicle systems to determine a real time location of the vehicle 104, as well as to store one or more tables for providing field shaping, as described in more detail below.

FIG. 1B depicts a cloud-based computing environment for field shaping, according to embodiments provided herein. As illustrated, the computing environment may include the network 100 coupled to components in the covered environment 102, such as a vehicle 104, a local computing device 106 (which may function as the local client device 106a and/or the local server 106b), and a remote computing device 110, as described with reference to FIG. 1A.

Similar to the local server 106b in FIG. 1A, the local computing device 106 may be configured as a bridge, desktop computer, laptop, tablet, mobile device, server, etc. In some embodiments, the local computing device 106 may be configured to provide administrative viewing and controls of the vehicle 104 and/or remote computing device 110. Other administrative controls may also be provided. The local computing device 106 may include a memory component. The memory component 140 may store the vehicle location logic 144b, which may be configured to determine a location of the vehicle 104 within a warehouse using one or more of a plurality of different technologies, such as UWB, wireless fidelity (Wi-Fi), wire guidance, cellular, etc. Thus, while the vehicle location logic 144b in FIG. 1B may be functionally similar to the vehicle location logic 144b from FIG. 1A, in FIG. 1A, the local server 108 may operate within or proximate the covered environment 102.

FIG. 1C depicts a table 160 for selecting a shaped field, according to embodiments provided herein. As illustrated, the table 160 may be configured to receive input from a computing device, such as the remote computing device 110 such as via an automatic process of the remote computing device 110, the local server 108 such as via an automatic process of the local server 108, and/or the local computing device 106, such as via a selection by an administrator. Regardless, the table 160 includes a vehicle column, which represents the vehicle type (and/or other identifier) for the entry. Also included is a speed column, a steer angle, an object type, and a shaped field. The speed column may represent a speed that the vehicle type may have to implement the identified shaped field. The steer angle column may represent the steer angle for the speed for the identified shaped field. The object type column may identify whether the object is a stationary object or a mobile object. The shaped field column may represent the selected shaped field for the criteria provided.

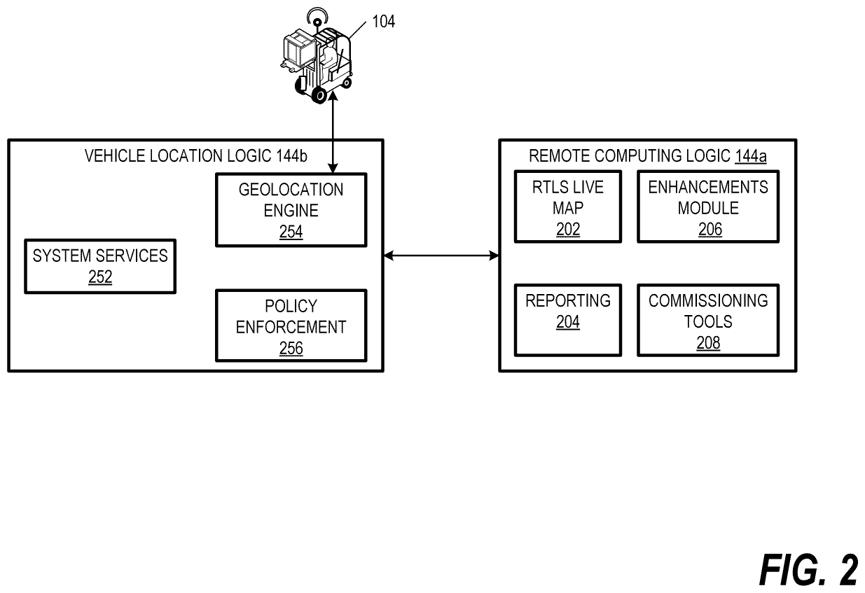

FIG. 2 depicts computing infrastructure associated with the remote computing logic 144a and the vehicle location logic 144b from FIGS. 1A and 1B, according to embodiments provided herein. As illustrated, the remote computing logic 144a may be configured as warehouse management software application with RTLS features for users to monitor, manage, and maintain the system. As such, the remote computing logic 144a may be configured as an interface to the RTLS system. The remote computing logic 144a may be configured to allow for administrators to monitor, configure, update, and maintain the RTLS system. Additionally, those with lower rights are able to view RTLS data and report on the RTLS data. The remote computing logic 144a may include one or more modules, which may be implemented in hardware, software, and/or firmware. As illustrated, the remote computing logic 144a may include an RTLS live map 202, a reporting module 204, an enhancements module 206, a commissioning tools module 208. The RTLS live map 202 may be configured as a graphical facility map showing icons for real time locations of all active UWB devices on the network 100 (representing vehicles, pedestrians, and potentially materials and/or other equipment) as well as tools to dive deeper into information regarding facility, vehicle, operator, tag, wearable device, and/or user. The RTLS live map 202 communicates with other components on the network 100.

The reporting module 204 may provide API access to a user to generate its own reports as well as provide additional data as part of existing reports. In some embodiments, reporting module 204 may contain enhanced and/or additional built-in reports covering topics such as traffic and congestion, impacts and near-misses, route playback, etc. As such, the reporting module 204 may include an API module, a reports module, a heat maps module, a route playback module, and/or other modules for providing the functionality described herein.

The enhancements module 206 may provide options for users to enhance and/or manage alerts, notifications, equipment, user data, etc. associated with telematics services provided for the vehicle 104. This management may be configured to permit the RTLS system to work with the features provided herein.

The commissioning tools module 208 may include tools to setup and manage the virtual representation of the facility and zones where the system should exercise control and/or awareness to UWB tags (such as vehicle 104, pedestrian tags, etc.). Additionally, the commissioning tools module 208 may be configured to provide tools to setup and manage the hardware and/or software on the downstream system components such as the server, anchors, and tags. These tools communicate to the other systems. Further, the commissioning tools module 208 may be configured to provide options for a user and/or administrator to define zones, design policies and/or rules associated with zones, as well as implement the zones, policies, and rules.

The vehicle location logic 144b may be the module where the bulk of tracking and control software resides to enable low latency, high accuracy vehicle tracking, vehicle reactions, and operator/user alerts. When implemented as hardware on-site (e.g., FIG. 1B), the vehicle location logic 144b may be configured as a physical server at the covered environment 102 dedicated to RTLS tasks. When implemented in the cloud (e.g., FIG. 1A), the vehicle location logic 144b may be configured as a virtual server in a cloud hosted data center off-site using third party machine computer capacity. The vehicle location logic 144b may be communicatively coupled to the transceiver anchors 314 (FIG. 3), which may be configured as UWB anchors which send/receive data wirelessly with the tag devices on the network. This data is then processed and distributed to the appropriate destination to the tag devices and/or through traditional networking to the components in the cloud.

As illustrated, the vehicle location logic 144b may include a system services module 252, a geolocation engine 254, and a policy enforcement module 256. The system services module 252 may be configured to monitor operation and/or health of RTLS components, which include hardware and/or software on the vehicle 104 that provide location tracking of the vehicle 104 (such as the anchors, tags, etc.). The system services module 252 may additionally be configured to setup, operate, and/or maintain the RTLS components. The system services module 252 may offer communication to and/or from the other system components such as the remote computing logic 144a and the vehicle 104, the vehicle 304, other vehicles, and/or pedestrians.

The geolocation engine 254 may be configured to manage UWB communications for the network 100, including high precision time syncing and location tracking. The geolocation engine 254 may include custom implementations of UWB software technologies to be employed for the RTLS features. Specifically, the geolocation engine 254 may be configured to utilize logical components for monitoring the location of the vehicles 104, 304, as well as send commands to the vehicles 104, 304.

The policy enforcement module 256 may be configured to arbitrate and apply policies to vehicles 104, 304. Policies enforced may include operational rules for multiple classes of interactions including: vehicle 104 and vehicle 304, vehicle 104 and pedestrian, vehicle 104 and restriction zone 320 (FIG. 3). Restriction zones 320 may be two pronged: first, the virtual representation of the area where a rule should be applied/enforced; and second, the policies/rules to be applied/enforced. As an example, end of aisle, pedestrian crossing, disallowed area, etc. with custom rules applied to vehicles 104 and/or pedestrians that result in slowdown and/or alerts. Policy enforcement module 256 may include sensor fusion technology and may communicate directly with the geolocation engine 254 to initiate the vehicle and pedestrian reactions in a timely manner. The policy enforcement module 256 may additionally store any field shaping tables and apply field shaping to the vehicles 104, 304, as described herein.

FIG. 3 depicts a vehicle 104 traversing a route in a covered environment 102, according to embodiments provided herein. As illustrated, the covered environment 102 may encompass any indoor or outdoor industrial facility in which materials handling vehicles transport goods including, but not limited to, indoor or outdoor industrial facilities that are intended primarily for the storage of goods, such as those where multi-level racks are arranged in aisles, and manufacturing facilities where goods are transported about the facility by vehicles 104 for use in one or more manufacturing processes. The covered environment 102 may include a plurality of objects, such as shelves 312 that define one or more aisles for the vehicle 104 to traverse. The covered environment 102 may additionally include a plurality of transceiver anchors 314, 316 (e.g. transceiver anchor 314a, transceiver anchor 314b, transceiver anchor 314c, transceiver anchor 316a, and/or transceiver anchor 316b).

The transceiver anchors 314 may be configured as UWB transmitters, while the transceiver anchors 316 may be configured as wireless fidelity (Wi-Fi) transmitters or other wireless protocol transmitters. As the transceiver anchors 314, 316 are located at fixed locations as a transceiver anchor (and/or coupled to a fixed object), the vehicle 104 may utilize data received from the transceiver anchors 314 and/or 316 to determine a location of the vehicle 104 in the covered environment 102. As such, the vehicle 104 may utilize the communication data to center the vehicle 104 in an aisle, as well as determine where in the covered environment 102 the vehicle 104 is located in order to traverse a route within the covered environment 102.

Also present in the covered environment 102 are mobile objects (e.g., pedestrian and second vehicle 304). The mobile objects may include any object that is configured to move (or could move) in the covered environment 102. In some embodiments, one or more of the mobile objects are coupled with a mobile wireless transmitter. As such, as the vehicle 104 traverses the covered environment 102, the vehicle 104 may encounter the pedestrian. The pedestrian may be coupled to a pedestrian tag. The vehicle 104 may access information such as footprint of the pedestrian (length and width of the pedestrian in the x-y plane), such that the vehicle 104 knows a safe path around the pedestrian. This may provide planning for the vehicle 104, as the vehicle 104 approaches the pedestrian.

Additionally, the covered environment 102 may include at least one restriction zone 320, such as a high traffic zone 320a and an end of aisle zone 320b. The high traffic zone 320a may be identified as an area with a high traffic volume and thus may require the vehicle 104 to reduce maximum speed while in the high traffic zone 320a. The end of aisle zone 320b may be configured similar to the high traffic zone 320a, except that the end of aisle zone 320b may cause the vehicle 104 to reduce speed due to a turn that the vehicle 104 must take. Similarly, facilities often have a rule that the vehicle 104 must come to a stop at the end of an aisle. If the operator does not come to a stop, the system will slow down the vehicle 104 so that it at least not traveling at full speed out of the aisle. As such, the high traffic zone 320a and/or the end of aisle zone 320b may be user-defined areas with user-defined rules that are marked and/or automatically identified to the remote computing device 110.

As described in more detail below, the restriction zones 320 may be configured to cause the vehicle 104 to utilize anchor-based control (or restriction). Specifically while a shaped detection field may be determined, upon the vehicle 104 approaching or entering one of the restriction zones 320, the shaped detection field may change and/or a determination may be made to stop utilizing the shaped detection field and only utilize the rules for the restriction zone 320. As an example, if the vehicle 104 enters the high traffic zone 320a, a determination may be made that the high traffic zone 320a requires a maximum speed of 2 miles per hour (mph). Thus the vehicle location logic 144b may cause a computing device to alter the shaped detection zone based on this new maximum speed; stop utilizing the shaped detection zone while in the high traffic zone 320a; and/or utilize a predetermined shaped detection zone for the high traffic zone 320a. As will be understood, the high traffic zone 320a may be determined automatically, based on an actual amount of traffic over time (or other criteria) and/or manually via an administrator identifying the high traffic zone 320a.

Similarly, some embodiments may be configured such that the end of aisle zone 320b is determined and created based on an inability for the vehicle sensors 112 to adequately detect objects while the vehicle 104 is located in the end of aisle zone 320b. In these embodiments, it may be impractical or useless for a vehicle 104 to utilize a shaped detection field that is based on vehicle sensor data. As such, the vehicle 104 may utilize the transceiver anchors 314 to detect the location of the vehicle 104 relative to other stationary and non-stationary objects in the covered environment 102.

The vehicle 104 may additionally encounter a second vehicle 304. The second vehicle 304 may include a transceiver anchor 314 that may be utilized to determine its own location via the transceiver anchors 314, 316. The vehicle 304 may additionally have one or more vehicle sensors for detecting operational characteristics of the vehicle 304.

It should be noted that the transceiver anchors 314, 316 may be configured as transmitters and/or receivers. As such, the transceiver anchors 314, 316 may include one or more hardware, software, and power to facilitate that functionality. Similarly, the vehicle transceiver 114 may be configured as a receiver and/or a transmitter, depending on the particular embodiment.

FIG. 4 depicts a user interface 430 for detecting a location and/or orientation of a vehicle in the covered environment 102, according to embodiments provided herein. As described above, embodiments provided herein may be configured to determine an orientation and/or vector of movement of the vehicle 104. Specifically, embodiments may utilize vehicle sensor data to determine a direction of motion and a steer angle of the vehicle 104. The covered environment 102 may be depicted as virtual warehouse 432 in FIG. 4. The vehicle 104 may be depicted as virtual vehicle 434. The location of the vehicle 104 (and other vehicles) may be determined via the transceiver anchors 314, 316 (FIG. 3) as point locations. The vehicle sensor data may then be utilized to determine the orientation of the vehicle 104. With the orientation and the, location, and operational data, a vector of movement may be determined for the vehicle 104. This may be depicted by orientating the virtual vehicle 434 in the user interface 430. As such, the user interface 430 may be configured to provide a real-time (or near real-time) depiction of the vehicle 104 and/or other vehicles in the covered environment 102.

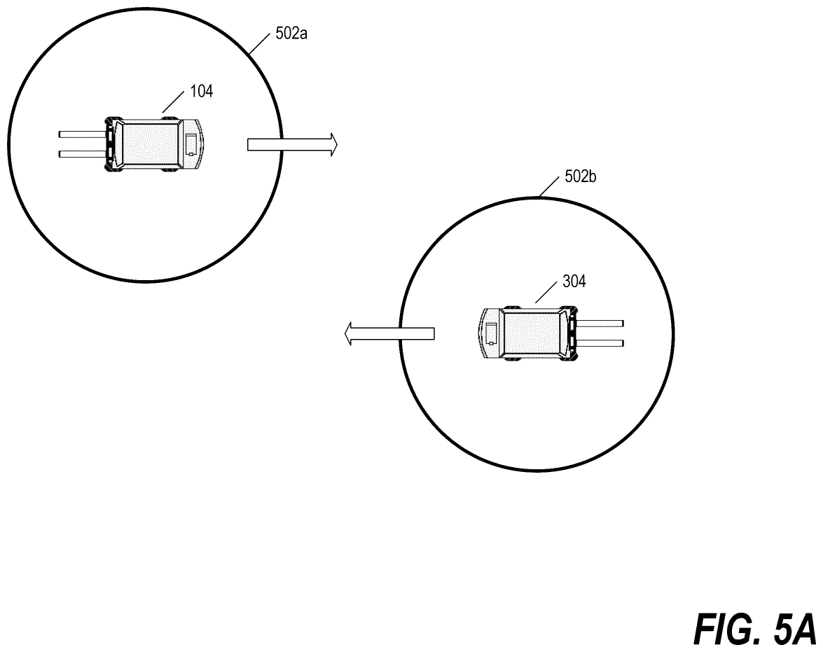

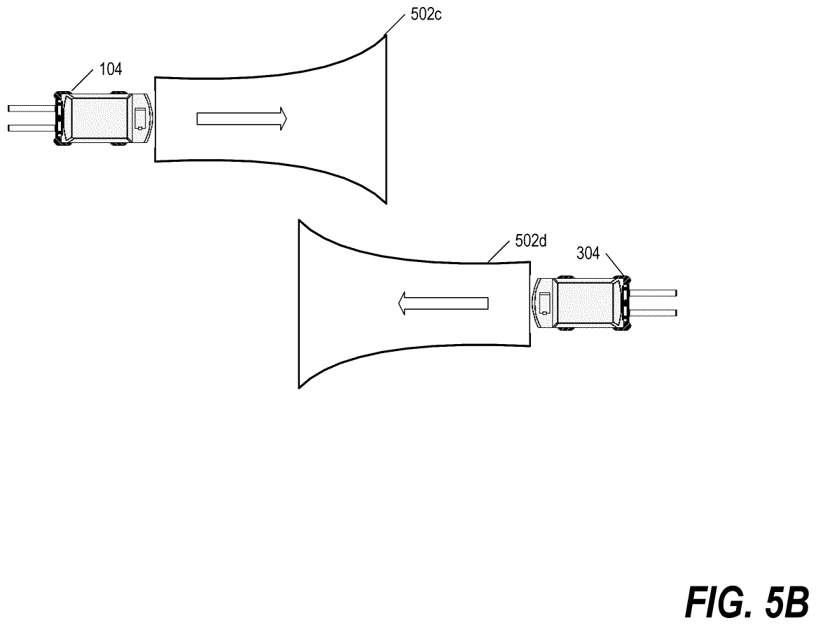

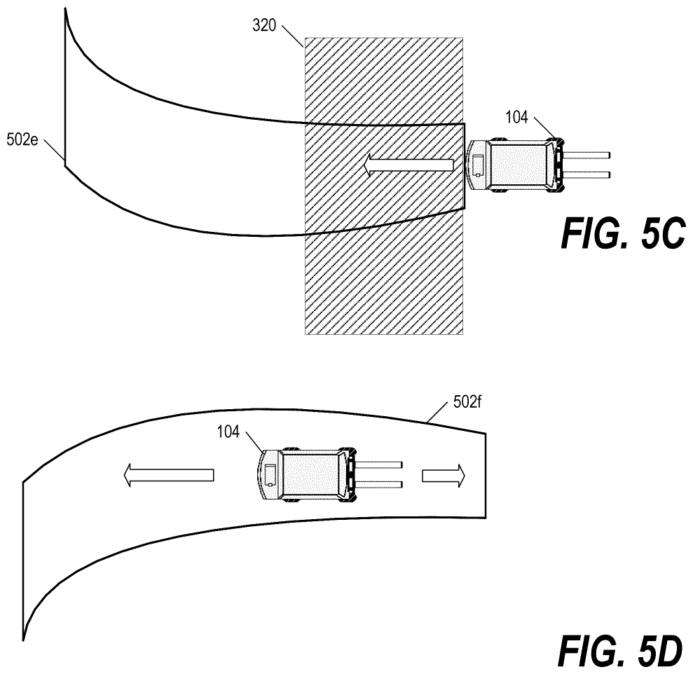

FIG. 5A depicts a plurality of vehicles 104, 304 with 360 degree detection fields 502a, 502b traversing a covered environment 102, according to embodiments provided herein. As illustrated, the vehicle 104 may be configured to create a 360 degree detection field 502a around the vehicle 104. The 360 degree detection field 502a may be a virtual field that identifies a zone, where if an object (such as the vehicle 304) enters that zone, the vehicle 104 will reduce maximum speed or take other preventative action to avoid a collision. Similarly, the vehicle 304 may include similar sensors and processing such that if an object (such as the vehicle 104) enters, the vehicle 304 may reduce maximum speed or take other preventative action to avoid a collision. Some embodiments may be configured to determine a location of the vehicle 104 and then create a virtual field a predetermined distance from that location in all directions. Specifically, the example of FIG. 5A illustrates utilizing only location data determined from the transceiver anchors 314, 316 (FIG. 3) without regard to orientation of the vehicle 104. As such, the detection fields 502a, 502b are circular in nature and do not account for orientation or vector of movement of the vehicles 104, 304.

While the detection fields 502a, 502b are useful for reducing the likelihood of a collision, because the detection fields 502a, 502b are primarily circular, objects may be detected that have little or no likelihood of colliding with the vehicle 104. As such, even though the current path of vehicles 104, 304 will likely not result in a collision, the detection fields 502a, 502b will have multiple instances of false alerts and/or slowdowns.

FIG. 5B depicts a plurality of vehicles 104, 304 with shaped detection fields 502c, 502d traversing a covered environment 102, according to embodiments provided herein. As illustrated, the vehicle 104 may be traversing a route (in the direction of the arrow). These embodiments may be configured to utilize direction of motion and steer angle data to determine orientation and vector of movement of the vehicle 104. In some embodiments, a probability analysis may be made regarding the current vector of movement. Specifically, a determination may be made regarding how likely the vehicle 104 will move to various spaces around the vehicle 104. This may be based on a location of other objects in the covered environment 102, a location of the vehicle 104 in the covered environment, and/or other data. This may be used to determine a likelihood of the vehicle 104 entering a space in the vicinity of the vehicle 104. If the probability of the vehicle 104 entering a space meets a predetermined probability threshold, the shaped detection field may be shaped to include that space. In some embodiments, a probability assessment may not be performed, but the shaped detection field is selected from a plurality of preconfigured shaped detection fields, based on vehicle type, vehicle speed, steer angle, location in the covered environment, etc. As illustrated in the example of FIG. 5B, because the vector of movement is currently straight, a shaped detection field 502c is created and/or selected that is very narrow in the vector of movement close to the vehicle 104. As the field moves away from the vehicle 104, the probability that the vehicle 104 will continue along the current direction are reduced, thus expanding the width of the shaped detection field 502c. The shaped detection field 502d may be similarly configured for the vehicle 304.

As illustrated in FIG. 5B, because only a small portion of the shaped detection fields are more tailored to the actual operation of the vehicles 104, 304, the vehicles 104, 304 will only be required to adjust operation if there is a certain likelihood of the vehicles 104, 304 crossing paths. Thus, normal operation of the vehicles 104, 304 may be maintained except in the rare circumstances that an actual issue exists.

It should be understood that FIG. 5C also depicts the shaped detection field 502c being created and/or selected based on a steer angle. Specifically, because a vehicle sensor 112 detects that the vehicle 104 is currently turning, embodiments may be configured to predict that the vehicle 104 will travel with that turn radius for a predetermined amount of time. Additionally, embodiments may understand that the vehicle 104 will likely not turn in 360 degrees and thus utilize the current position of the vehicle 104 in the covered environment 102 to determine the shaped detection field. Specifically, if the vehicle 104 is turning as depicted in FIG. 5C, embodiments may determine that the vehicle 104 is turning a corner and may additionally predict that once the corner is turned, the vehicle 104 will travel straight for a certain distance. With this information and prediction, embodiments may create and/or select a shaped detection field accordingly.

FIG. 5C depicts a shaped detection field 502e that may be created and/or selected for a vehicle 104, based on a determination that the vector of movement includes a turn and/or travel through a restriction zone 320, according to embodiments provided herein. In some embodiments, the vehicle 104 may determine its location in the covered environment 102. If the vehicle 104 determines that the vehicle 104 is entering a restriction zone 320 that includes a predetermined rule, the vehicle 104 may comply with that rule, despite the shaped detection field.

As an example, if the restriction zone 320 includes an instruction that sensor-based data should not be used (presumably because the sensor data is less than reliable in this situation), the vehicle 104 may utilize the rules for that zone, such that the shaped detection field 502e may be ignored while in the restriction zone 320. Some embodiments may be configured to cause an alteration of the shaped detection zone 502e because of the presence of the restriction zone 320. As an example, a determination may be made the vehicle 104 will travel 7 mph, but recognize that in the restriction zone 320, the vehicle 104 will only travel 2 mph. As such, the shape and size of the shaped detection zone 502 may change.

FIG. 5D depicts a shaped detection field 502f that may be created and/or selected for a vehicle 104, based on vehicle location being in an area where the vehicle 104 is to turn around, according to embodiments provided herein. Similar to the shaped detection field 502e, the shaped detection field 502f may be preselected, based on a vehicle 104 entering a predetermined area of the covered environment 102 and/or based on a predetermined route that will cause the vehicle 104 to enter the predetermined area. Referring back of FIG. 3, the vehicle 104 may be routed to pick up a payload. As such, the vehicle 104 must slow down, stop pick up the payload, turn around, and return to the area from which the vehicle 104 came. Thus, when the vehicle 104 enters an area proximate to the payload, the vehicle 104 may utilize the shaped detection field 502f. Thus, if an object enters the shaped detection field 502f, the vehicle 104 may implement alterations to operation, such as reducing maximum speed. As will be understood, these embodiments may understand the task that the vehicle 104 is performing, where the task will be performed, and the actions the vehicle 104 will take to perform the task. With this information, the shaped detection field 502f may be created.

As another example, a shaped detection field 502f may be selected and/or determined when the vehicle 104 reaches the payload. Accordingly, when the vehicle 104 enters an area of the covered environment 102 corresponding to the payload, a predetermined field may be determined for the vehicle 104 that reflects the likely directions that the vehicle 104 will take to perform the desired task. Once the vehicle 104 exits the predetermined area, a new shaped detection field may be implemented for the vehicle 104.

It should also be understood that embodiments provided herein may be configured to create new shaped detection fields. Specifically, embodiments may be configured to provide an interface for an administrator to select an area to apply a shaped detection field. The administrator may select the shaped detection field, based on the area. Some embodiments may be configured to recommend areas to apply shaped detection fields. Similarly, some embodiments may be configured to automatically and without user intervention determine the shape of the field, based on vehicle-specific criteria (type of vehicle, route, operator, etc.), and/or based on typical operation in that area.

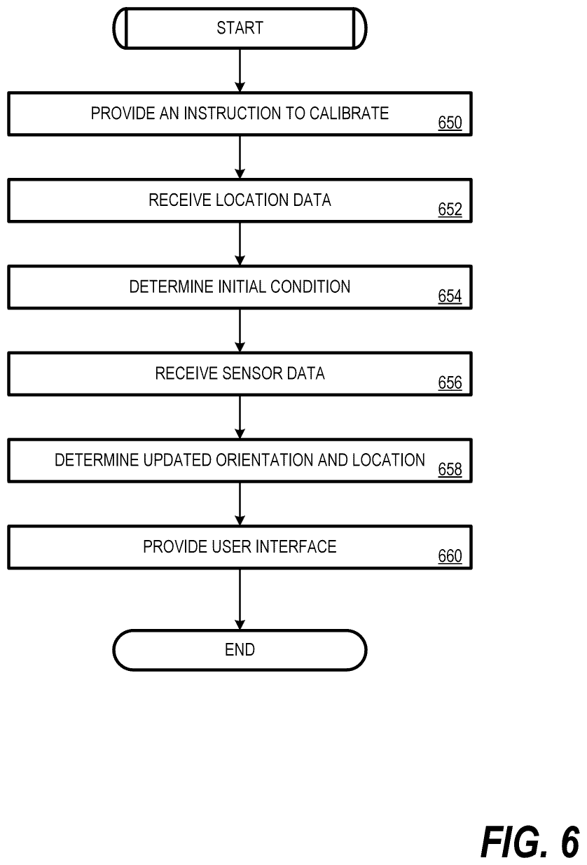

FIG. 6 depicts a flowchart for determining a vehicle orientation, according to embodiments provided herein. As illustrated in block 650, an instruction to the vehicle 104 may be provided to calibrate an orientation determination of the vehicle 104 in the covered environment 102. In block 652, data related to a first plurality of locations of the vehicle 104 may be received from the vehicle 104, determined via a UWB transceiver on the vehicle 104, where the vehicle 104 only includes one UWB transceiver. In block 654, a determination may be made (from the data) regarding a first initial orientation of the vehicle 104. Specifically, UWB data may be polled from the vehicle 104 for a predetermined distance. This data seeding may assume the vehicle 104 is traveling forward and may thus determine an initial orientation, based on this data seeding. In block 656, vehicle sensor data may be received from a sensor on the vehicle 104. In block 658, an updated vehicle orientation and an updated vehicle location may be determined, based on the data and the vehicle sensor data. As described above, the vehicle sensor data may include speed data, steer data, gyroscope data, etc. With the sensor data, embodiments may determine an incremental change in position and/or orientation of the vehicle 104. In some embodiments the various streams of sensor data may be fused, such as through a dynamic weighting function. The dynamic weighting function may include discrete weights based on predetermined criteria (e.g., predetermined weights based on vehicle location, vehicle speed, etc.). As an example, if a vehicle is traveling over a threshold speed, UWB data may have less relevancy and may thus be weighted less. If gyroscope data deviates over a predetermined threshold (e.g., more than 10%) from a previous reading, this data may be weighted less.

In block 660, a user interface may be provided that includes a depiction of the vehicle 104 in the updated vehicle orientation and the updated vehicle location. It will be understood that some embodiments may be configured to determine that the updated vehicle orientation and/or the updated vehicle location is against a predetermined policy and alter operation of the vehicle 104, such as by providing an alert to a user of the vehicle 104 to correct the updated vehicle orientation and/or the updated vehicle location.

Similarly, some embodiments may be configured to receive data related to a second plurality of locations of the vehicle 104. This data may be received from the vehicle 104 via the UWB transceiver. A second initial orientation of the vehicle 104 may be determined and the second initial orientation of the vehicle 104 may be compared with the updated vehicle orientation. In response to determining that the second initial orientation of the vehicle 104 varies from the updated vehicle orientation by a predetermined threshold, the updated vehicle orientation may be replaced with the second initial orientation.

It will be understood that the embodiment of FIG. 6 improves the technical field of using sensor data to determine a location and/or orientation of a materials handling vehicle, first because using sensor data in this manner is an inventive concept. Further, the embodiment provided in FIG. 6 improves the technical field by improving the speed by which orientation data may be provided. Specifically, to the extent UWB data could be used to determine a location and orientation, such data is delayed. Using sensor data in this manner vastly improves the presentation of the real-time orientation and location of the vehicle 104.

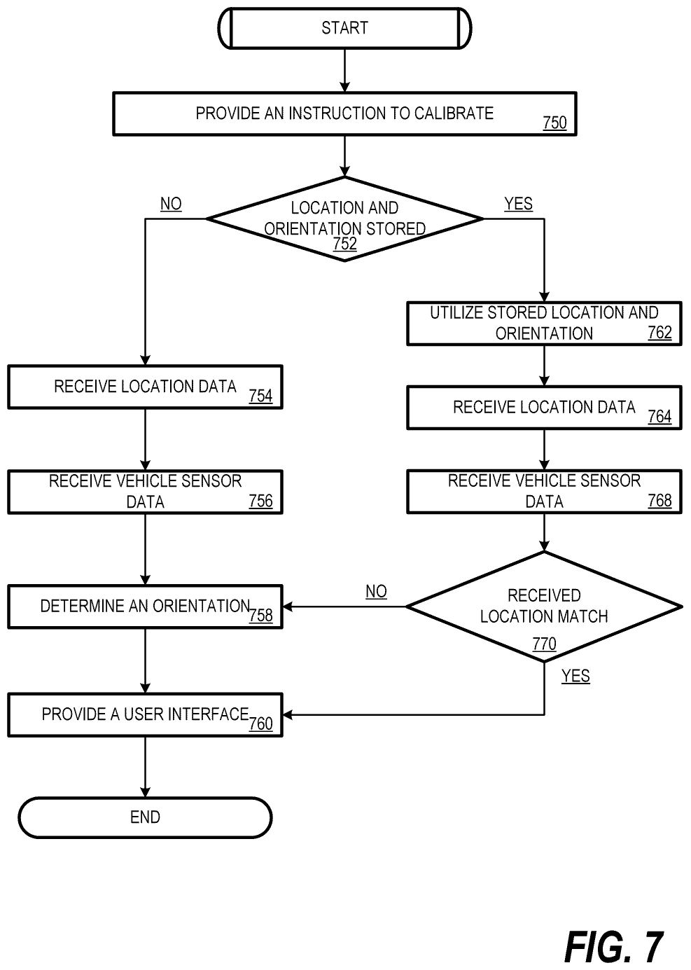

FIG. 7 depicts a flowchart for calibrating a vehicle, according to embodiments provided herein. As illustrated in block 750, an instruction to calibrate may be received. In block 752, a determination may be made regarding whether a location and orientation are stored. If not, in block 754, location data may be received. In block 756 vehicle sensor data may be received. In block 758, an orientation may be determined. In block 760, a user interface may be provided. If at block 752, location and orientation are stored, in block 762, the stored location and orientation may be utilized. In block 764, location data may be received. In block 768, vehicle sensor data may be received. In block 770 a determination may be made regarding whether a location match is received. If not, the process proceeds to block 758 to determine an orientation. If at block 770, the location match is received, the process moves to block 760 to provide the user interface.

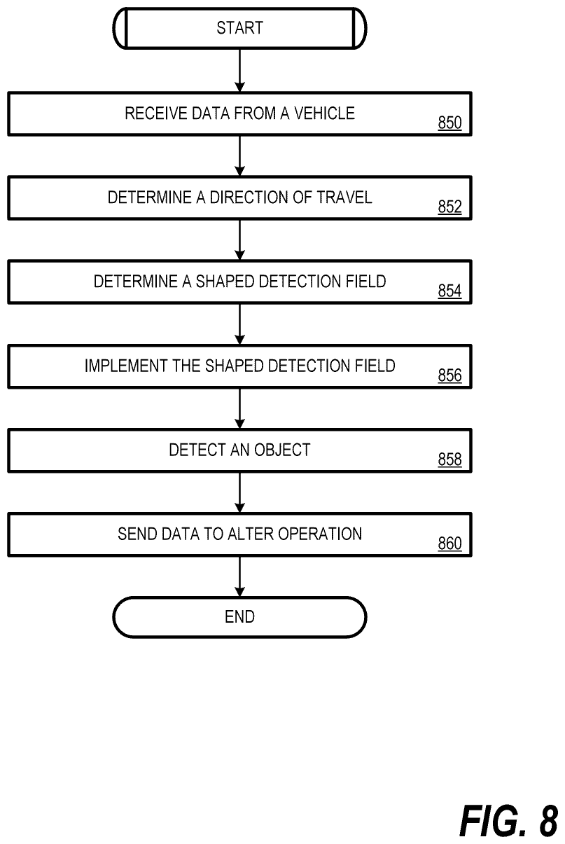

FIG. 8 depicts a flowchart for field shaping, according to embodiments provided herein. As illustrated in block 850, data may be received from a vehicle 104 in a covered environment 102. The data may include a direction of motion of the vehicle 104 and a steer angle of the vehicle 104 as detected by at least one on-board vehicle sensor. In block 852, a determination may be made from the data of a vector of movement of the vehicle 104. In block 854, a determination may be made based on the vector of movement of the vehicle 104, a shaped detection field. The shaped detection field may be configured for monitoring an area that is defined based on a probability of the vehicle 104 moving into the space. In some embodiments, the shaped detection field may be determined based on a direction of a vector of movement. In some embodiments, the shaped detection field is determined by predicting a path of travel of the materials handling vehicle.

Regardless, in block 856, the shaped detection field may be implemented for the vehicle 104. In block 858, an object that encroaches on the shaped detection field may be detected. In block 860, information may be sent to the vehicle 104 to alter operation of the vehicle 104 to move the materials handling vehicle such that the object is out of the shaped detection field. Specifically, some embodiments may be configured to send an alert to a user of the vehicle 104 and/or send a control signal to alter operation of the vehicle 104 directly (such as a slowdown). Some embodiments may be further configured to receive new sensor data of the vehicle 104 in the covered environment 102, select a different predetermined shaped detection field for the vehicle 104, and implement the different predetermined shaped detection field for the vehicle 104.

It will be understood that the embodiments provided in FIG. 8 represent embodiments that improve the technical field of utilizing a shaped detection field for a materials handling vehicle. These embodiments improve the technical field by increasing the maximum speed by which a materials handling vehicle can travel, by reducing slowdowns. Additionally, by using vehicle sensor data, the responsiveness of field determination, selection and/or creation is increased because the senor data is received and processed faster than UWB or other network data. These embodiments also provide a technical effect or integrates these embodiments into a practical application by causing an alteration in the operation of the vehicle 104.

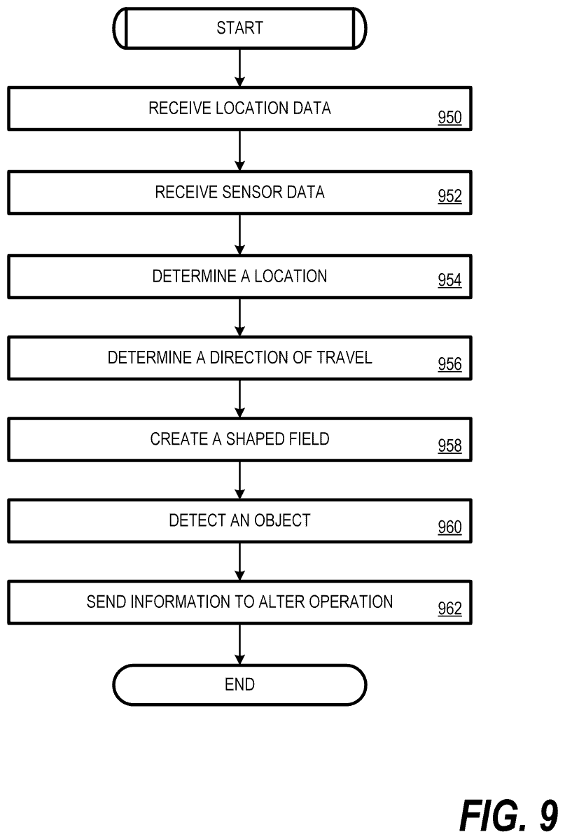

FIG. 9 depicts another flowchart for field shaping, according to embodiments provided herein. As illustrated in block 950, location data may be received from the vehicle 104 related to a location of the vehicle 104 in a covered environment 102. In block 952, sensor data from a sensor on the vehicle 104 may be received related to a characteristic of operation of the vehicle 104. In block 954, a determination may be made from the location data regarding a first location of the vehicle 104 in the covered environment 102. In block 956, a determination may be made from the sensor data a vector of movement. The vector of movement may be determined from an orientation of the vehicle 104. In block 958, a shaped detection field may be created and/or selected for the vehicle 104 from the vector of movement of the vehicle 104 and the first location of the vehicle 104. The shaped detection field may be configured for monitoring a space that is defined based on a probability of the vehicle 104 moving into the space. In block 960, an object may be detected that encroaches on the shaped detection field. In block 962, information may be sent to the vehicle 104 to alter operation of the vehicle 104 to reduce a likelihood of collision with the object. Specifically, some embodiments may be configured to send an alert to a user of the vehicle 104 and/or send a control signal to alter operation of the vehicle 104 directly.

It will be understood that some embodiments may be configured to determine a second location of the vehicle 104 in the covered environment 102. These embodiments may determine that the second location has changed from the first location and adjust the shaped detection field based on the changed location. Similarly, some embodiments may be configured to determine a third location of the vehicle 104 in the covered environment 102. These embodiments may determine that the third location is identified as providing a zone-based shaped detection field that does not utilize the orientation of the vehicle 104 and utilize the zone-based shaped detection field while the vehicle 104 is located in the third location.

As will be understood, embodiments provided in FIG. 9 improve the technical field of utilizing shaped detection fields for a materials handling vehicle. Specifically, these embodiments may improve the speed at which shaped detection fields are determined and/or selected by utilizing vehicle sensor data, as described above. These embodiments also provide a technical effect or integrates these embodiments into a practical application by causing an alteration in the operation of the vehicle 104.

FIG. 10 depicts the remote computing device 110, according to embodiments provided herein. As illustrated, the remote computing device 110 includes a processor 1030, input/output hardware 1032, a network interface hardware 1034, a data storage component 1036 (which stores vehicle data 1038a, premises data 1038b, and/or other data), and a memory component 140. The memory component 140 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD) (whether local or cloud-based), and/or other types of non-transitory computer-readable medium. Depending on the particular embodiment, these non-transitory computer-readable mediums may reside within the remote computing device 110 and/or external to the remote computing device 110.

The memory component 140 may store operating logic 1042, the remote computing logic 144a and the vehicle location logic 144b. Each of these logic components may include a plurality of different pieces of logic, each of which may be embodied as a computer program, firmware, and/or hardware, as an example. A local interface 1046 is also included in FIG. 10 and may be implemented as a bus or other communication interface to facilitate communication among the components of the remote computing device 110.

The processor 1030 may include any processing component operable to receive and execute instructions (such as from a data storage component 1036 and/or the memory component 140). As described above, the input/output hardware 1032 may include and/or be configured to interface with speakers, microphones, and/or other input/output components.

The network interface hardware 1034 may include and/or be configured for communicating with any wired or wireless networking hardware, including an antenna, a modem, a LAN port, wireless fidelity (Wi-Fi) card, WiMAX card, mobile communications hardware, transceiver, and/or other hardware for communicating with other networks and/or devices. From this connection, communication may be facilitated between the remote computing device 110 and other computing devices.

The operating logic 1042 may include an operating system and/or other software for managing components of the remote computing device 110. As discussed above, the remote computing logic 144a may be configured to cause the processor 1030 to provide user interfaces, define zones, and/or perform other actions, as described herein. The vehicle location logic 144b may be configured to cause the processor 1030 to utilize transceiver anchors and/or other technologies to determine a location of the vehicle 104 in the warehouse, as well as provide and apply field shaping.

It should be understood that while the components in FIG. 10 are illustrated as residing within the remote computing device 110, this is merely an example. In some embodiments, one or more of the components may reside external to the remote computing device 110 or within other devices, such as the vehicle 104, the local computing device 106, and/or the local server 108 depicted in FIGS. 1A, 1B. It should also be understood that, while the remote computing device 110 is illustrated as a single device, this is also merely an example. In some embodiments, the remote computing logic 144a and/or the vehicle location logic 144b may reside on different computing devices.

As an example, one or more of the functionalities and/or components described herein may be provided by the remote computing device 110, the vehicle 104, the local computing device 106, and/or the local server 108. Depending on the particular embodiment, any of these devices may have similar components as those depicted in FIG. 10. To this end, any of these devices may include logic for performing the functionality described herein.

Additionally, while the remote computing device 110 is illustrated with the remote computing logic 144a and the vehicle location logic 144b as separate logical components, this is also an example. In some embodiments, a single piece of logic may provide the described functionality. It should also be understood that while the remote computing logic 144a and the vehicle location logic 144b are described herein as the logical components, this is also an example. Other components may also be included, depending on the embodiment.

As illustrated above, various embodiments are disclosed. These embodiments may be configured to create and implement shaped detection fields around a vehicle 104, such as a materials handling vehicle. These embodiments improve the functioning of a materials handling vehicle by customizing these virtual shaped detection fields that the materials handling vehicle utilizes to automatically and without user input adjust operation.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

It should now be understood that embodiments disclosed herein include systems, methods, and non-transitory computer-readable mediums for systems and methods for shaped detection fields. It should also be understood that these embodiments are merely exemplary and are not intended to limit the scope of this disclosure.

What is claimed is:

1. A system for location-based field shaping comprising:
a materials handling vehicle in a covered environment that includes a vehicle transceiver for receiving a communication from a plurality of transceiver anchors that are affixed to stationary objects within the covered environment, wherein the materials handling vehicle further includes at least one sensor for detecting a characteristic of operation of the materials handling vehicle; and
a computing device that includes a processor and a memory component, the memory component storing logic that, when executed by the processor, causes the system to perform the following:
receive location data via at least one of the plurality of transceiver anchors, the data related to a location of the materials handling vehicle in the covered environment;
receive sensor data from the at least one sensor related to the characteristic of operation of the materials handling vehicle;
determine, from the location data, a first location of the materials handling vehicle in the covered environment;
determine, from the sensor data, a vector of movement of the materials handling vehicle, wherein the vector of movement includes an orientation of the materials handling vehicle;
determine a shaped detection field for the materials handling vehicle from the vector of movement of the materials handling vehicle and the first location of the materials handling vehicle, wherein the shaped detection field is configured for monitoring an area that is defined based on a probability of the materials handling vehicle moving into the area;
detect an object that encroaches on the shaped detection field; and
send information to the materials handling vehicle to alter operation of the materials handling vehicle to reduce a likelihood of collision with the object.

2. The system of claim 1, wherein the logic is further configured to perform at least the following:
determine a second location of the materials handling vehicle in the covered environment;
determine that the second location is in a different location of the covered environment than the first location; and
adjust the shaped detection field based on the different sector of the covered environment.

3. The system of claim 1, wherein the logic further causes the system to perform at least the following:
determine that the location is identified as providing a zone that provides zone-based shaped detection field; and
implement the zone-based shaped detection field while the materials handling vehicle is located in the zone.

4. The system of claim 1, wherein the shaped detection field is selected from a plurality of preconfigured shaped detection fields based on at least one of the following: space, traffic, vehicle type, or operator.

5. The system of claim 1, wherein the logic further causes the system to provide a live map to an administrator, wherein the live map provides a representation of at least one of the following:
the materials handling vehicle, the orientation, or the shaped detection field.

6. The system of claim 1, wherein the plurality of transceiver anchors are ultra-wide band (UWB) antennas.

7. The system of claim 1, wherein the object includes at least one of the following: a second vehicle, a pedestrian, or a zone.

8. The system of claim 1, wherein the at least one sensor includes at least one of the following: a light radar (LiDAR), a steering wheel sensor, an odometer, a wireline sensor, a gyroscope, an accelerometer, a magnet, a single UWB transceiver, or an onboard inertial measurement unit (IMU).

9. A method for location-based field shaping comprising:
receiving, by a computing device, location data related to a location of the materials handling vehicle in a covered environment;
receiving, by the computing device, sensor data from a sensor on the materials handling vehicle related to a characteristic of operation of the materials handling vehicle;
determining, by the computing device, from the location data, a first location of the materials handling vehicle in the covered environment;
determining, by the computing device, from the sensor data, a vector of movement, wherein the vector of movement includes an orientation of the materials handling vehicle;
creating, by the computing device, a shaped detection field for the materials handling vehicle from the vector of movement of the materials handling vehicle and the first location of the materials handling vehicle, wherein the shaped detection field is configured for monitoring an area that is defined based on a probability of the materials handling vehicle moving into the area;
detecting, by the computing device, an object that encroaches on the shaped detection field; and
sending, by the computing device, information to the materials handling vehicle to alter operation of the materials handling vehicle to reduce a likelihood of collision with the object.

10. The method of claim 9, further comprising:
determining a second location of the materials handling vehicle in the covered environment;
determining that the second location is in a different location of the covered environment than the first location; and
adjusting the shaped detection field based on the different location of the covered environment.

11. The method of claim 9, further comprising:
determine that the location is identified as a zone that provides a zone-based shaped detection field; and
implement the zone-based shaped detection field while the materials handling vehicle is located in the location.

12. The method of claim 9, wherein the shaped detection field is selected from a plurality of preconfigured shaped detection fields based on at least one of the following: space, traffic, vehicle type, or operator.

13. The method of claim 9, further comprising providing a live map to an administrator, wherein the live map provides a representation of at least one of the following: the materials handling vehicle, the orientation, or the shaped detection field.

14. The method of claim 9, wherein the object includes at least one of the following: a second vehicle, a pedestrian, or a zone.

15. The method of claim 9, wherein the sensor includes at least one of the following: a light radar (LiDAR), a steering wheel sensor, an odometer, a wireline sensor, a gyroscope, an accelerometer, a magnet, a single UWB transceiver, or an onboard inertial measurement unit (IMU).

16. A system for location-based field shaping comprising:
a materials handling vehicle for traversing a covered environment;
at least one vehicle sensor on the materials handling vehicle for detecting a characteristic of operation of the materials handling vehicle;
a vehicle transceiver on the materials handling vehicle for communicating with a plurality of transceiver anchors that are placed on respective stationary objects within the covered environment for detecting a location of the materials handling vehicle in the covered environment; and
a computing device that includes a processor and a memory component, the memory component storing logic that, when executed by the processor, causes the system to perform the following:
receive location data from the materials handling vehicle via the vehicle transceiver, the location data related to a location of the materials handling vehicle in the covered environment;
receive sensor data from the at least one vehicle sensor related to the characteristic of operation of the materials handling vehicle;
determine, from the location data, a first location of the materials handling vehicle in the covered environment;
determine, from the sensor data, a vector of movement of the materials handling vehicle, wherein the vector of movement includes an orientation of the materials handling vehicle;
determine a shaped detection field for the materials handling vehicle from the vector of movement of the materials handling vehicle and the first location of the materials handling vehicle, wherein the shaped detection field is configured for monitoring an area that is defined based on a probability of the materials handling vehicle moving into the area;
detect an object that encroaches on the shaped detection field; and
send information to the materials handling vehicle to alter operation of the materials handling vehicle to reduce a likelihood of collision with the object.

17. The system of claim 16, wherein the logic is further configured to perform at least the following:
determine a second location of the materials handling vehicle in the covered environment;
determine that the second location is in a different location of the covered environment than the first location; and
adjust the shaped detection field based on the different location of the covered environment.

18. The system of claim 16, wherein the shaped detection field is selected from a plurality of preconfigured shaped detection fields based on at least one of the following: space, traffic, vehicle type, or operator.

19. The system of claim 16, wherein the plurality of transceiver anchors are ultra-wide band (UWB) transceivers.

20. The system of claim 16, wherein the at least one vehicle sensor includes at least one of the following: a light radar (LiDAR), a steering wheel sensor, an odometer, a wireline sensor, a gyroscope, an accelerometer, a magnet, a single UWB transceiver, or an onboard inertial measurement unit (IMU).
